(19) United States
(12) Patent Application Publication
(10) Pub. No.: US 2020/0192999 A1
(43) Pub. Date: Jun. 18, 2020

(54) Systems and Methods for Authenticating Music Credits

(71) Applicant: SKWIBB HOLDINGS LLC, Greenwich, CT (US)

(72) Inventors: Charles Morgan Royce, JR., New York, NY (US); Christopher Joseph Jones, Brooklyn, NY (US)

(73) Assignee: SKWIBB HOLDINGS LLC, Greenwich, CT (US)

(21) Appl. No.: 16/719,193

(22) Filed: Dec. 18, 2019

Related U.S. Application Data
(60) Provisional application No. 62/781,490, filed on Dec. 18, 2018.

(51) Int. Cl. G06F 21/10; G06F 16/638; H04L 29/06; H04M 1/725; G06F 16/68; G06F 16/23

(52) U.S. Cl. CPC G06F 21/10; G06F 16/639; H04L 63/08; G06F 2221/0722; G06F 16/686; G06F 16/235; H04L 2463/101; H04M 1/72558

(57) ABSTRACT

Systems and methods for crediting a profile for a musical work through authentication of a credit is provided. The system comprises a processor in communication with a database. The processor receives a selection of a credit for a musical work to be attributed to an invited profile from an authorized administrator for the musical work, or a request for a credit from an administrator of a profile. The processor updates the database to include the credit as a pending credit, and generates an electronic credit invitation or a credit request including the pending credit. The credit invitation or credit request is transmitted to the invited profile administrator or the musical work administrator, respectively. The processor determines whether the invited profile administrator or the musical work administrator authorizes the pending credit and updates a status of the pending credit in the database based on the determination.

### CROSS REFERENCE TO RELATED APPLICATIONS

This application claims the benefit of priority to U.S. Provisional Patent Application Ser. No. 62/781,490 filed on Dec. 18, 2018, the entire disclosure of which is expressly incorporated herein by reference.

### BACKGROUND

### Technical Field

The present disclosure relates to systems and methods for authenticating music credits. More particularly, the present disclosure relates to systems and methods for authenticating music credits through an authentication engine that utilizes a double verification system.

### Related Art

Current music players allow users to listen to his or her favorite music and expose users to new music. However, a user listening to a song or album is often unaware of the music industry professionals credited for the song, e.g., vocals, guitar, bass guitar, piano, producing, composing, etc. This limits the user's exposure to music industry professionals and those music industry professionals' work that he or she would otherwise enjoy. As a result, a user may not be able to search for music based on a specific music industry professional and the music industry professional's credits. For example, a user may enjoy a song where Music Industry Professional A is credited with playing bass guitar, and may desire to search for other songs where Music Industry Professional A is credited with playing bass guitar.

Furthermore, for such a crediting system to function properly, it is important that the credits be accurate. In some instances, a music industry professional may be erroneously credited for a song to which he or she did not actually contribute. In such instances, a user may find a new song expecting to hear his or her new favorite music industry professional, only to find out that the music industry professional was erroneously credited for the song. This erroneous crediting may have been done by accident, or may have been done on purpose in an effort to increase the number of times the song is listened to, or to take advantage of the famous music industry professional's namesake.

Accordingly, there exists a need for a system and method that allows users to find music based on musician crediting, and which authenticates the credits prior to applying the credits.

### SUMMARY

Example embodiments of the present disclosure relate to systems and methods for authenticating music credits.

Specifically, a method for crediting a profile for a musical work, which can be an album, song, single, or other known musical works, through authentication of the credit com is provided. The method includes the step of receiving an electronic credit invitation for a musical work to be attributed to an invited profile from an authorized administrator for the musical work. The method further includes the steps of generating an electronic credit invitation that includes the credit, and transmitting the credit invitation to an administrator of the invited profile. The method also includes the steps of receiving authorization of the credit from the administrator of the invited profile, and authenticating the credit. Further, the method includes the step of updating a database to credit the profile for the musical work.

In another embodiment of the present disclosure, a method for crediting a profile on a musical work through authentication of the credit is provided. The method includes the step of receiving a request for credit for a musical work from an administrator of a profile. The method further includes the steps of generating a credit request message that includes the credit and transmitting the credit request message to an administrator of the musical work. The method also includes the steps of receiving authorization of the credit from the administrator of the musical work, and authenticating the credit. Further, the method includes the step of updating a database to credit the profile for the musical work.

The present disclosure also provides a system for crediting a profile for a music work through authentication of the credit. The system can include an authentication system including a server and a database. The server can include a memory having an authentication engine stored thereon, a network interface, and a processor that can be configured to authenticate a musical credit. Specifically, the processor performs the step of receiving an electronic credit invitation for a musical work to be attributed to an invited profile from an authorized administrator for the musical work. The processor also performs the steps of generating an electronic credit invitation that includes the credit, and transmitting the credit invitation to an administrator of the invited profile. The processor also performs the steps of receiving authorization of the credit from the administrator of the invited profile and authenticating the credit. Further, the processor performs the step of updating a database to credit the invited profile for the musical work.

In another embodiment of the present disclosure, a system for crediting a profile for a music work through authentication of the credit is provided. The system can include an authentication system including a server and a database. The server can include a memory having an authentication engine stored thereon, a network interface, and a processor that can be configured to authenticate a musical credit. Specifically, the processor performs the step of receiving a request for credit for a musical work from a profile. The processor also performs the steps of generating a credit request message that includes the credit and transmitting the credit request message to an administrator of the musical work. The processor also performs the steps of receiving authorization of the credit from the administrator of the musical work, and authenticating the credit. Further, the processor performs the step of updating a database to credit the requesting profile for the musical work.

### BRIEF DESCRIPTION OF THE DRAWINGS

The foregoing features of the invention will be apparent from the following Detailed Description, taken in connection with the accompanying drawings, in which:

FIG. 1 is a schematic diagram illustrating a system for authenticating music credits in accordance with the present disclosure;

FIG. 2 is a diagram illustrating hardware and software components of the authentication server of the present disclosure;

FIG. 3 is a flowchart illustrating the processing steps for authenticating a music credit generated by an administrator;

FIG. 4 is a flowchart illustrating administrator steps for selecting a credit to attribute to a profile;

FIG. 5 is a flowchart illustrating the processing steps for authenticating a music credit requested by a profile;

FIG. 6 is a flowchart illustrating user steps for requesting credit(s);

FIG. 7 is a screenshot of a user interface of the present disclosure displayed on an administrator's smart device or a user's smart device showing an artist's music library;

FIG. 8 is a screenshot of the user interface displaying a single from an artist's music library;

FIG. 9 is a screenshot of the user interface displaying an album from an artist's music library;

FIG. 10 is a screenshot of the user interface displaying the credits screen for a single after an administrator for the single selects the credits icon;

FIG. 11 is a screenshot of the user interface displaying the credits screen for an album after one of the album's administrators selects the credits icon;

FIG. 12 is a screenshot of the user interface displaying a credits screen for a song playing through a music player to one of the song's administrators;

FIG. 13 is a screenshot of the user interface displaying an edit credits screen for a single after one of the single's administrators has selected an EDIT button on the music credits screen;

FIG. 14 is a screenshot of the user interface displaying a profile search screen;

FIG. 15 is a screenshot of the user interface displaying a credit category search screen;

FIG. 16 is a screenshot of the user interface displaying a credit category search screen including search results;

FIG. 17 is a screenshot of the user interface displaying a credit category search screen including an added credit category;

FIG. 18 is a screenshot of the user interface showing a select songs screen for an album credit;

FIG. 19 is a screenshot of the user interface displaying an electronic credit invitation review screen for a musical work classified as a single to one of the single's administrators;

FIG. 20 is a screenshot of the user interface displaying an electronic credit invitation review screen for a musical work classified as a song from an album to one of the song's administrators;

FIG. 21 is a screenshot of the user interface displaying an electronic credit invitation review screen for a musical work classified as an album to one of the album's administrators;

FIG. 22 is a screenshot of the user interface displaying a confirmation pop-up;

FIG. 23 is a screenshot of the user interface displaying the edit credits screen to one of the single's administrators after the administrator has sent an electronic credit invitation for this single;

FIG. 24 is a screenshot of the user interface displaying the credits screen to this single's administrators with a newly added pending credit displayed;

FIG. 25 is a screenshot of the user interface displaying the credits screen for this song playing through the music player to one of this song's administrators including the pending credit invitation added;

FIG. 26 is a screenshot of the user interface displaying a profile;

FIG. 27A is a screenshot of the user interface displaying a credits screen for a profile;

FIG. 27B is a screenshot of the user interface displaying a credits screen for a profile for a specific album that has been selected and showing the songs that the profile is credited on from that album;

FIG. 27C is a screenshot of the user interface displaying a credits screen for a profile for a specific album that has been selected and showing all songs from that album;

FIG. 28 is a screenshot of the user interface displaying an electronic credit invitation message for a single;

FIG. 29 is a screenshot of the user interface displaying an electronic credit invitation message for an album;

FIG. 30 is a screenshot of the user interface displaying the music credits screen of FIG. 24 to any administrator of this single after the invited profile has accepted a pending credit and the credit has been authorized;

FIG. 31 is a screenshot of the user interface displaying to any administrator of this song the credits for the song being played through the music player after the credit has been authorized;

FIG. 32 is a screenshot of the user interface displaying the credits screen for a profile;

FIG. 33 is a screenshot of the user interface displaying the edit credits screen for a single as shown in FIG. 23 after the pending credit has been authenticated for the single;

FIG. 34 is a screenshot of the user interface displaying an edit credits screen for a specific profile in connection with a single that is displayed after the administrator has selected the profile from the edit credits screen shown in FIG. 33 for that single;

FIG. 35 is a screenshot of the user interface showing an edit credits screen for a specific profile in connection with an album that is displayed after the administrator has selected the profile from the edit credits screen for that album;

FIG. 36 is a screenshot of the user interface showing a warning popup after an administrator of a musical work has chosen to delete a credit from a profile;

FIG. 37 is a screenshot of the user interface showing a confirmation pop-up after an administrator of a musical work has successfully deleted a credit from a profile;

FIG. 38 is a screenshot of the user interface showing the edit credits screen for a single with a delete profile command;

FIG. 39 is a screenshot of the user interface showing a warning popup after an administrator of a single has chosen to delete a credited profile from the single;

FIG. 40 is a screenshot of the user interface showing a confirmation pop-up after an administrator has successfully deleted a credited profile from a single;

FIG. 41 is a screenshot of the user interface displaying a credits screen for a single after a non-administrator of the single selected or clicked on a credits icon for the single;

FIG. 42 is a screenshot of the user interface showing a credits screen for an album after a non-administrator of the album selected or clicked on the credits icon for the album;

FIG. 43 is a screenshot of the user interface displaying a credits screen to a non-administrator of a song playing through the music player;

FIG. 44 is a screenshot of the user interface showing a request credit screen for a single;

FIG. 45 is a screenshot of the user interface showing the request credit screen with a plurality of potential credit categories;

FIG. 46 is a screenshot of the user interface showing a request credit screen for a single including a credit to be requested;

FIG. 47 is a screenshot of the user interface showing a select songs screen for an album credit request;

FIG. 48 is a screenshot of the user interface displaying a profile's request credit review screen for a musical work classified as a single;

FIG. 49 is a screenshot of the user interface displaying a request credit review screen for a musical work classified as a song from an album;

FIG. 50 is a screenshot of the user interface displaying a request credit review screen for a musical work classified as an album;

FIG. 51 is a screenshot of the user interface displaying a confirmation pop-up;

FIG. 52 is a screenshot of the user interface showing the credits screen after the user has sent a credit request for a single;

FIG. 53 is a screenshot of the user interface showing the credits screen after the user has sent a credit request for an album;

FIG. 54 is a screenshot of the user interface showing a profile;

FIG. 55 is a screenshot of the user interface showing a credits screen for a profile;

FIG. 56 is a screenshot of the user interface showing the credits for a song being played through the music player to a profile that has a pending credit request;

FIG. 57 is a screenshot of the user interface showing a credit request message for a single;

FIG. 58 is a screenshot of the user interface showing a credit request message for an album;

FIG. 59 is a screenshot of the user interface showing the music credits screen of FIG. 52 after a musical work's administrator has accepted the credit request and the credit has been authorized;

FIG. 60 is a screenshot of the user interface showing the credits screen for a profile;

FIG. 61 is a screenshot of the user interface showing the request credit screen for a specific profile in connection with a single;

FIG. 62 is a screenshot of the user interface showing the request credit screen of FIG. 61 after a non-administrator of this musical work has added a new credit;

FIG. 63 is a screenshot of the user interface showing a warning popup displayed after a non-administrator of this musical work deletes a credit from his or her profile;

FIG. 64 is a screenshot of the user interface showing a warning popup that is displayed after a non-administrator of this musical work deletes the last credit for his or her profile on a specific song or album;

FIG. 65 is a screenshot of the user interface showing a warning popup that is displayed after an administrator of this profile deletes an album or single credit field from this profile's credit screen; and

FIG. 66 is a screenshot of the user interface showing a confirmation pop-up after a non-administrator of a musical work has successfully deleted a credit from his or her profile.

### DETAILED DESCRIPTION

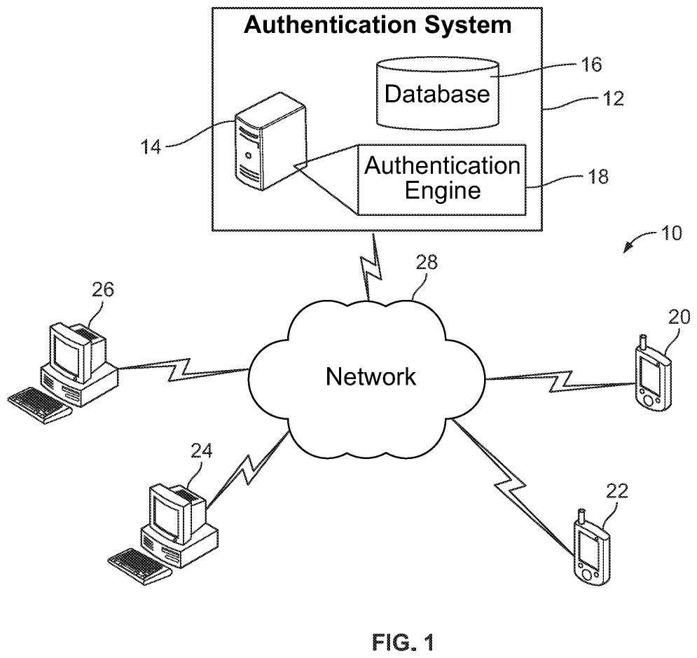

The present disclosure relates to systems and methods for authenticating music credits, as discussed in detail below in connection with FIGS. 1-66.

FIG. 1 is a schematic diagram illustrating a system 10 for authenticating music credits in accordance with the present disclosure. The system 10 generally includes an authentication system 12 that can include an authentication server 14, a database 16, and an authentication engine 18 executed by the server 14. The database 16 stores information relating to songs, albums, profiles, profiles' credits, etc. The database 16 can be internal to the authentication server 14, or separate from the authentication server 14 but in communication therewith. The authentication engine 18 receives authentication invitations or requests, processes the authentication invitations or requests, and confirms or denies the authentication invitations or requests. The authentication system 12 can communicate with one or more administrator smart devices 20, one or more user smart devices 22, one or more administrator computer systems 24, and one or more user computer systems 26 by way of a network 28, e.g., the Internet. Specifically, each of the administrator smart devices 20, user smart devices 22, administrator computer systems 24, and user computer systems 26 can run an application thereon that permits the devices and systems to send information to and receive information from the authentication system 12 via the network 28. In this regard, the administrator smart devices 20 and the administrator computer system 24 can send credit invitations to the authentication system 12, and can receive credit requests from the authentication system 12, while the user smart devices 22 and user computer systems 26 can send credit requests to the authentication system 12, and can receive credit invitations from the authentication system 12. Furthermore, each of the administrator smart devices 20, user smart devices 22, administrator computer systems 24, and user computer systems 26 can receive music, information regarding the music, and user information from the authentication system 12 for playing and viewing purposes. It should also be understood that the authentication system 12 can be cloud-based.

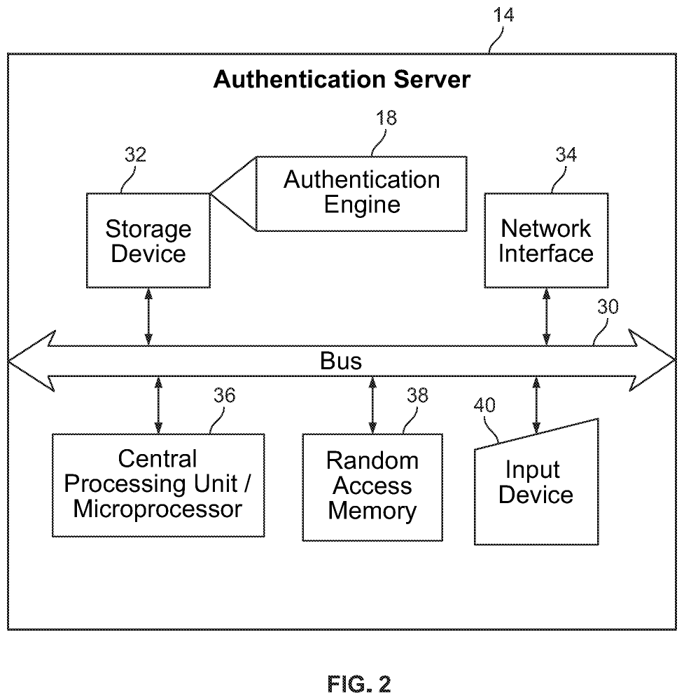

FIG. 2 is a diagram illustrating hardware and software components of the authentication server 14 of the present disclosure, and on which the system of the present disclosure could be implemented. The authentication server 14 can include a communications bus 30, a storage device 32 that has stored thereon the authentication engine 18, a network interface 34, a central processing unit (CPU) (microprocessor) 36, a random access memory (RAM) 38, and one or more input devices 40. The authentication server 14 can also include a display (e.g., a liquid crystal display (LCD), a cathode ray tube (CRT), etc.) The storage device 32 can comprise any suitable, computer-readable storage medium such as disk, non-volatile memory (e.g., read-only memory (ROM), erasable programmable ROM (EPROM), electrically-erasable programmable ROM (EEPROM), flash memory, field-programmable gate array (FPGA), etc.) The authentication server 14 could be a networked computer system, a personal computer, a smart phone, a tablet computer, etc. It is noted that the authentication server 14 need not be a networked server, and indeed, could be a stand-alone computer system.

The functionality provided by the present disclosure could be provided by a specialized authentication engine 18, which could be embodied as computer-readable program code stored on the storage device 32 and executed by the CPU 36 using any suitable high or low level computer language, such as Python, Java, C, C++, C#, .NET, MATLAB, etc. The network interface 34 could include an Ethernet network interface device, a wireless network interface device, or any other suitable device which permits the authentication server 14 to communicate via the network 28 or with the Internet. The CPU 36 could include any suitable single-core or multi-core microprocessor of any suitable architecture that is capable of implementing and running the specialized authentication engine 18 (e.g., an Intel processor). The RAM 38 could include any suitable, high-speed, random access memory typical of most modern computers, such as dynamic RAM (DRAM), etc.

The present system includes an application that is operable on the more user computer systems 26 by way of a network 28, e.g., the Internet. Specifically, each of the administrator smart devices 20, user smart devices 22, administrator computer systems 24, and user computer systems 26, and can receive information from, and send information to, the authentication server 14. The authentication system 12 allows administrators of musical works to submit invitations to profiles for credit on a song, single, or album, and for the invited profile to verify and confirm the credit via the authentication system 12. Similarly, the authentication system 12 allows for administrators of profiles to request credit on a song, single, or album, from an administrator of a song, single, or album, and for the administrator of that musical work to verify and confirm the credit request via the authentication system 12. It should be understood that a user can be any user authorized to use the authentication system 12, including music industry professionals and the general public, and that administrators of a musical work can be administrators of a specific song, single, or album that is stored on the database 16 or administrators can be authentication system administrators that have direct access to the authentication server 14. If a user is an administrator of a profile that includes musical works, then the administrator of that profile also administrates all musical works associated with that profile, including albums, songs, and singles.

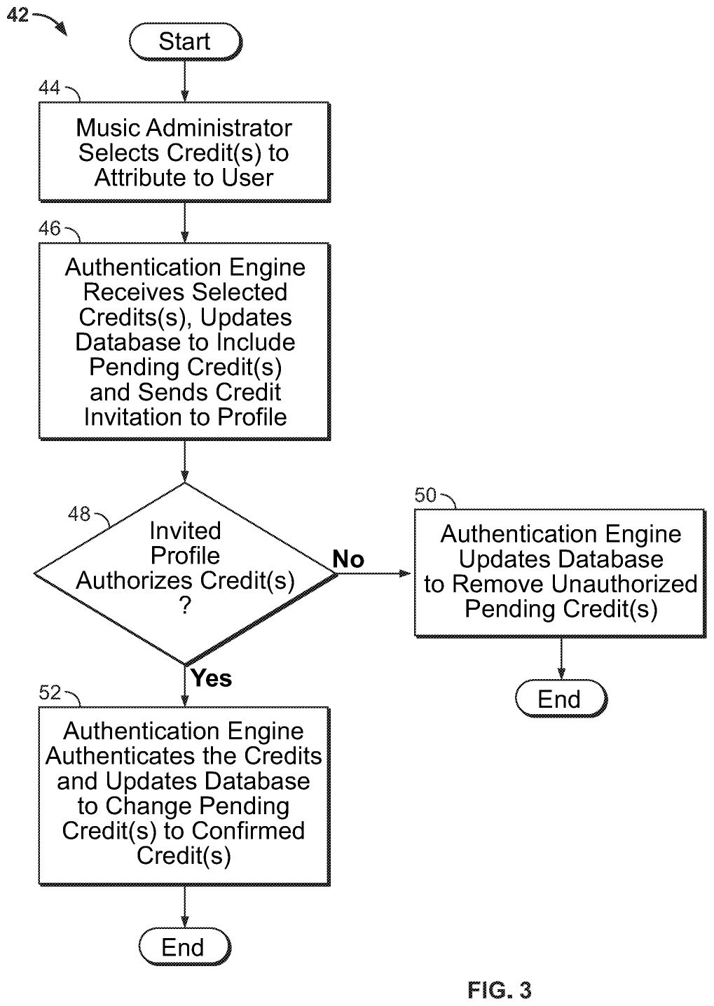

FIG. 3 is a flowchart illustrating authentication processing steps 42 carried out by the system 10 for authenticating a music credit generated by an administrator of a musical work. In step 44, the administrator of a musical work selects one or more credits to be attributed to a profile for a specific song, single, or album. For example, the administrator of the musical work can specify a particular profile to be credited for playing the drums and performing the vocals on a particular song, a particular single, or one or more songs of a particular album. It should be understood that credit can be provided for a multitude of different categories, including, but not limited to, vocals, guitar, bass guitar, harmonica, synthesizers, congas, piano, electric piano, finger piano, producing, remixing, composing, producing, etc. In step 46, after the administrator of the musical work selects the one or more credits to be attributed to a profile, the authentication engine 18 receives the selected credits, updates the database 16 to include pending credits for the profile for the selected song, single, or one or more songs of a particular album, and sends an electronic credit invitation to the profile for confirmation and approval. The administrators of the invited profile can view the credit invitation, and in step 48, decide whether to confirm and approve the credit(s), or deny the credit(s). If a negative determination is made, e.g., the administrator of the invited profile did not authorize the credit(s), the process 42 proceeds to step 50 where the authentication engine 18 updates the database 16 by removing the unauthorized pending credit(s). If a positive determination is made, e.g., the administrators of the invited profile confirms and approves the credit(s), the authentication engine 18 authenticates the credit(s) that have been confirmed and updates the database to change the pending credit(s) that were authenticated to confirmed credit(s). In doing so, the authentication engine 18 attaches the profile to the relevant song, single, or album with the authenticated credits, and also attaches those songs, singles, or albums for which the profile has been authenticated to the profile's credits screen. Accordingly, when a second user views a song for which a profile has an authenticated credit, the second user will be able to see in the information for that song the profile's credit. Additionally, when a second user views a profile, the second user will be able to see the profile's credits that have been authenticated. The authentication engine 18 can also make pending credits visible to the public, visible to only administrators, and/or visible only to the profile for which the credit is pending.

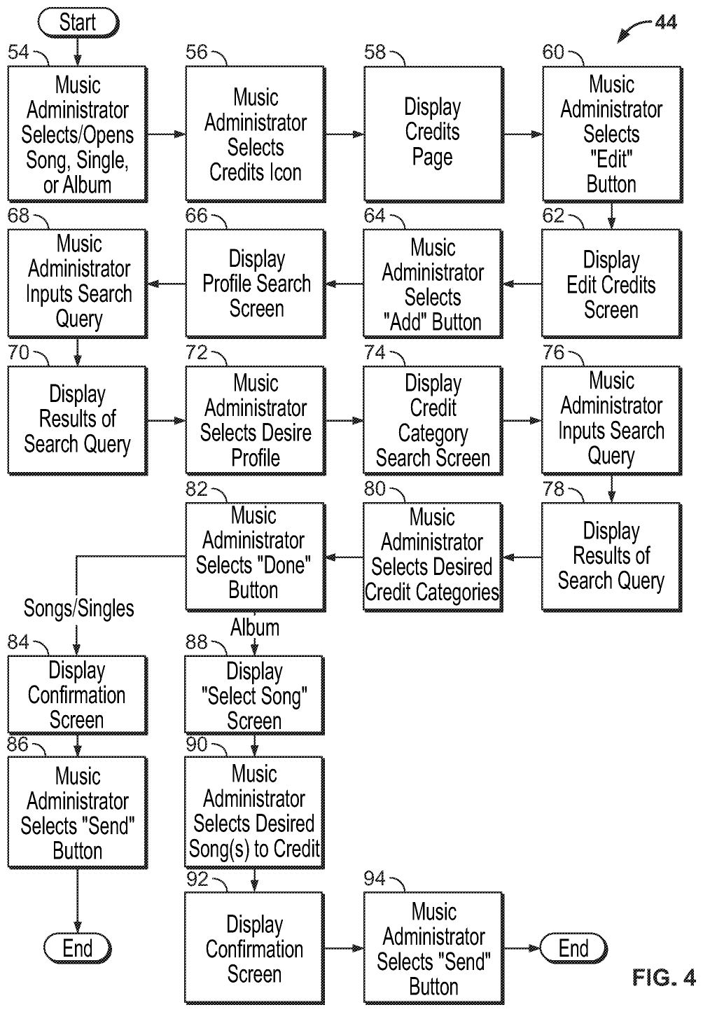

FIG. 4 is a flowchart illustrating musical work administrator steps for selecting a credit to attribute to a profile (step 44 of FIG. 3) in greater detail. In step 54, the musical work administrator selects/opens a desired song, single, or album. This can be a musical work that the administrator is currently listening to, or a musical work that is being opened specifically for the purpose of adding a credit. In step 56, the musical work administrator selects or clicks on a credits icon in the user interface. In step 58, the user interface displays a credits page for that musical work. The credits page can show all of the credits currently authorized for that music work, and in some instances any pending credits. In step 60, the musical work administrator selects or clicks on an “Edit” button on the credits page shown in the user interface. In step 62, the user interface changes and displays an edit credits screen. In step 64, the musical work administrator selects or clicks on an “Add” button, which is used to add credits to the selected musical work. In step 66, the user interface displays a profile search screen, which includes a search bar and allows the musical work administrator to search for the profile which he or she would like to credit. In step 68, the musical work administrator inputs a search query, e.g., the profile that he or she would like to credit, into the search bar. In step 70, the user interface displays the results of the search query. This can by a dynamic display in which the user interface updates the results each time the musical work administrator inputs an additional letter. In step 72, the musical work administrator selects the desired profile that he or she would like to credit. In step 74, the user interface displays a credit search screen, which includes a search bar and allows the musical work administrator to search for categories to be credited, e.g., vocals, guitar, bass guitar, etc. In step 76, the musical work administrator inputs a search query, e.g., the category that he or she would like to credit, into the search bar. In step 78, the user interface displays the results of the search query. This can by a dynamic display in which the user interface updates the results each time the administrator inputs an additional letter. In step 80, the musical work administrator selects the desired credit categories he or she would like to credit to the profile. In step 82, the musical work administrator selects or clicks on a “Done” button in the user interface. In the case of a song or single being credited, the process proceeds to step 84 where the user interface displays a confirmation screen that includes the profile being credited, the category the profile is being credited for, and the song or single that the profile is being credited on, along with a “Send” button. In step 86, the musical work administrator selects or clicks on the “Send” button, and the authentication processing steps 42 proceeds to step 46 as discussed in connection with FIG. 3.

In the case of an album being credited, after the musical work administrator selects or clicks on the “Done” button in step 82, the process proceeds to step 88 where the user interface displays a “Select Songs” screen. The “Select Songs” screen includes a listing of the songs on the album, allowing the musical work administrator to select which songs the profile should be credited for. In step 90, the musical work administrator can select each song from the album that they desire to credit the profile for. In step 92 the user interface displays a confirmation screen that includes the profile being credited, the category the profile is being credited for, the album the profile is being credited for, and the songs from the album that the profile is being credited for, along with a “Send” button. In step 94, the musical work administrator selects or clicks on the “Send” button, and the authentication processing steps 42 proceeds to step 46 as discussed in connection with FIG. 3.

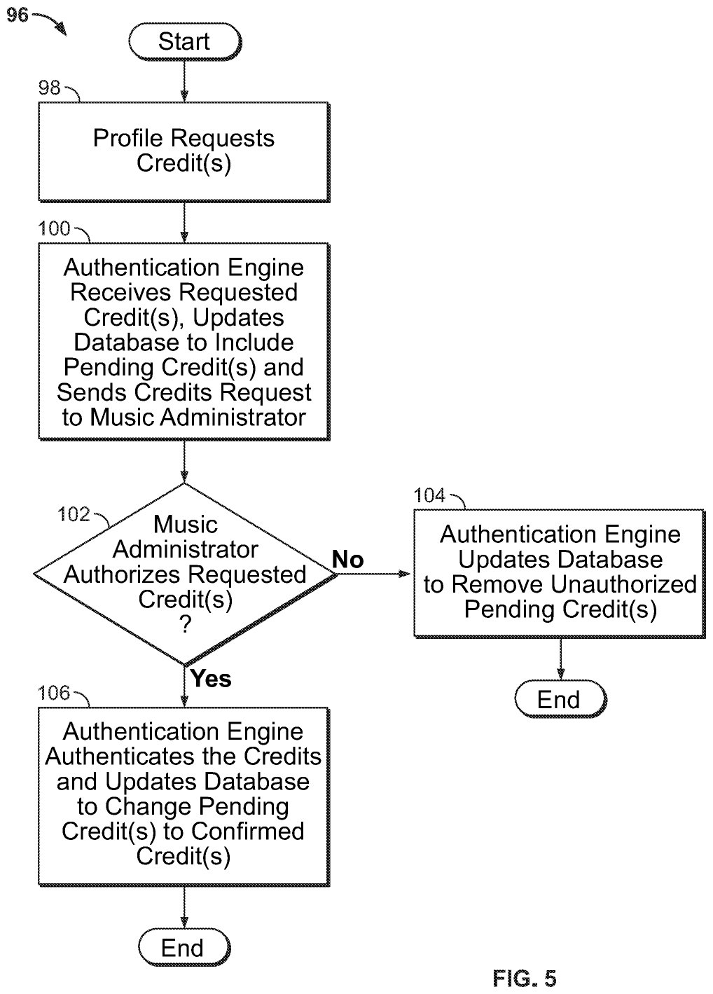

The system 10 not only allows musical work administrators to issue credits to profiles and send invitations to those profiles in connection with the credits, but also allows non-administrators of a musical work to request credit for a song, single, or album from the administrators of that song, single, or album. FIG. 5 is a flowchart illustrating the authentication processing steps 96 carried out by the system 10 for authenticating a music credit requested by a profile. In step 98, a profile administrator selects and requests one or more credits to be attributed to the profile for a specific song, single, or album. For example, the profile administrator can request that the profile be credited for playing the drums and performing the vocals on a particular song, a particular single, or one or more songs of a particular album. It should be understood that credit can be provided for a multitude of different categories, including, but not limited to, vocals, guitar, bass guitar, harmonica, synths, congas, piano, electric piano, finger piano, producing, remixing, composing, producing, etc. In step 100, after the profile administrator requests the one or more credits to be attributed to the profile, the authentication engine 18 receives the requested credits, updates the database 16 to include pending credits for the profile for the selected song, single, or one or more songs of a particular album, and sends the credit request to the administrator of that musical work for confirmation and approval. The musical work administrator can view the credit request, and decide in step 102 whether to confirm and approve the credit(s), or deny the credit(s). If a negative determination is made, e.g., the musical work administrator did not authorize the credit(s), the process 96 proceeds to step 104 where the authentication engine 18 updates the database 16 by removing the unauthorized pending credit(s). If a positive determination is made, e.g., the musical work administrator confirms and approves the credit(s), the authentication engine 18 authenticates the credit(s) that have been confirmed by the musical work administrator and updates the database to change the pending credit(s) that were authenticated to confirmed credit(s). In doing so, the authentication engine 18 attaches the profile to the relevant song, single, or album with the authenticated credits, and also attaches those songs, singles, or albums for which the profile has been authenticated to the profile. Accordingly, when a second user views a song that a profile has an authenticated credit for he or she will be able to see in the information for that song the profile's credit. Additionally, when a second user views a profile, he or she will be able to see the profile's credits that have been authenticated. The authentication engine 18 can also make pending credits visible to the public, visible to only administrators, and/or visible only to the profile for which the credit is pending.

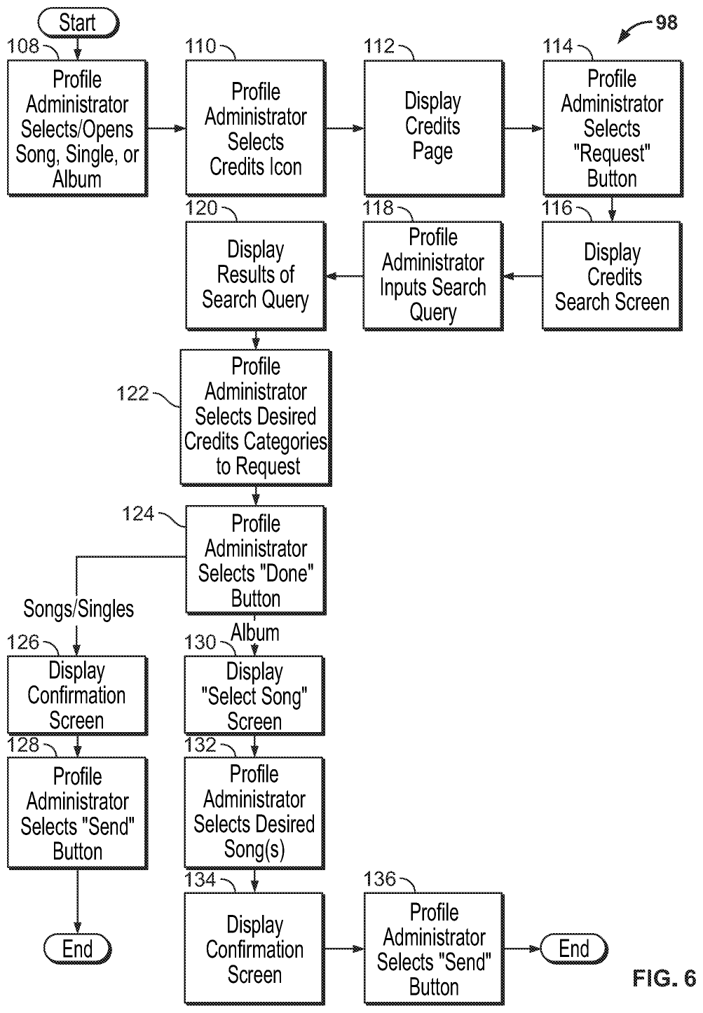

FIG. 6 is a flowchart illustrating user steps for requesting credits on behalf of a profile (step 98 of FIG. 5), in greater detail. In step 108, the profile administrator selects/opens a desired musical work. This can be a musical work that the profile administrator is currently listening to, or a musical work that is being opened specifically for the purpose of adding a credit. In step 110, the profile administrator selects or clicks on a credits icon in the user interface. In step 112, the user interface displays a credits page for that musical work. The credits page can show all of the credits currently authorized for that musical work, and in some instances any pending credits. In step 114, the user selects or clicks on a “Request” button which appears on the credits page shown in the user interface, e.g., since this user is not an administrator of the musical work. In step 116, the user interface displays a credit search screen, which includes a search bar and allows the profile administrator to search for categories for which to request credits, e.g., vocals, guitar, bass guitar, etc. In step 118, the user inputs a search query, e.g., the category that the user would like to request credits for, into the search bar. In step 120, the user interface displays the results of the search query. This can by a dynamic display in which the user interface updates the results each time the user inputs an additional letter. In step 122, the profile administrator selects the desired credit categories for which the user would like the current profile they are administrating to be credited. In step 124, the profile administrator selects or clicks on a “Done” button in the user interface. In the case of a song or single being credited, the process 98 proceeds to step 126 where the user interface displays a confirmation screen that includes the profile requesting credit, the category the profile is requesting credit for, and the song or single that the profile is requesting credit for, along with a “Send” button. In step 128, the profile administrator selects or clicks on the “Send” button, and the authentication processing steps 96 proceed to step 100 as discussed in connection with FIG. 5.

In the case of an album being credited, after the profile administrator selects or clicks on the “Done” button in step 124, the process 98 proceeds to step 130 where the user interface displays a “Select Songs” screen. The “Select Songs” screen includes a listing of the songs on the album, allowing the profile administrator to select which songs the profile would like to request credits for on behalf of the profile the user is administrating. In step 132, the profile administrator can select each song from the album that the user would like to request credit for on behalf of the profile the user is administrating. In step 134 the user interface displays a confirmation screen that includes the profile requesting credit, the category the profile is requesting credit for, and the song or songs that the profile is requesting credit for, the album on which the song or songs appear, along with a “Send” button. In step 136, the profile administrator selects or clicks on the “Send” button, and the authentication processing steps 96 proceed to step 100 as discussed in connection with FIG. 5.

The system 10 also includes additional functionality, such as allowing profile administrators to remove or delete credits, which can be done through the user interface displayed on each of the administrator smart devices 20, user smart devices 22, administrator computer systems 24, and user computer systems 26.

It should be understood that each profile can have one or more administrators that are authorized to use and make decisions for that profile. Moreover, when referring to profiles, it should be understood that a profile can be for an individual user or music industry professional, or that a profile can be a group profile that includes multiple profiles as members of the group profile. Such a group profile could have one or more administrators that are authorized to use and make decisions for that group profile. Group profiles, much like individual user and music industry professional profiles, can be credited on singles, songs, and albums, e.g., for horn section, producer team, record label, mastering studio, etc.

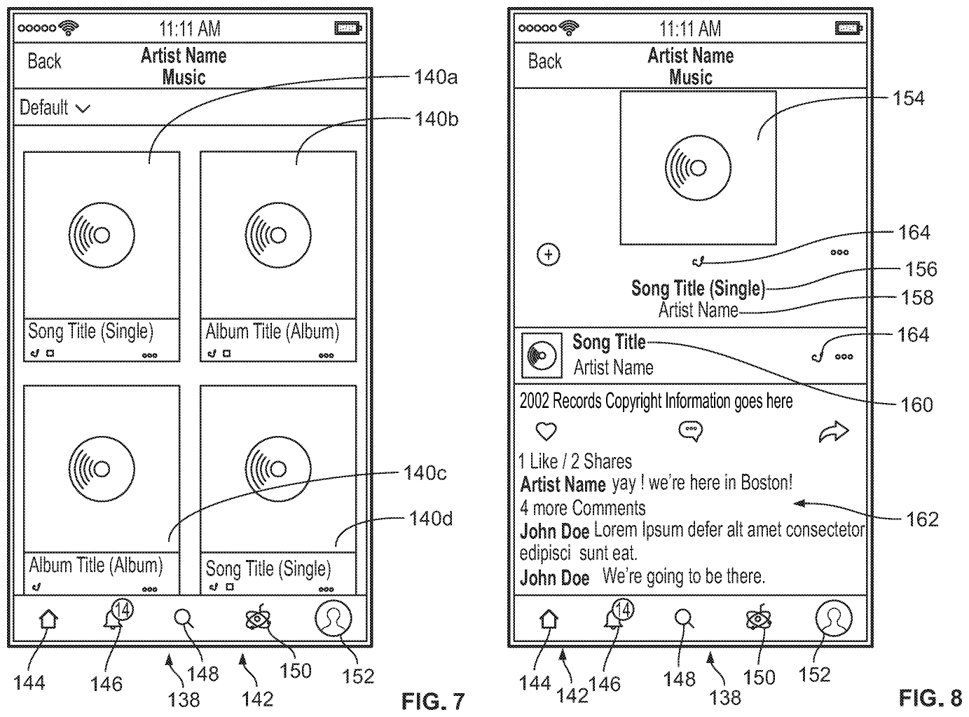

FIG. 7 is a screenshot of a user interface 138 of the present disclosure displayed on an administrator's smart device 20 or a user's smart device 22, and showing an artist's music library. It should be understood that the user interface 138 can also be displayed on an administrator's computer 24 or a user's computer 26. It should also be understood that when reference is made to a user, such user may also be a music industry professional for which credit is being given or requested. As shown in FIG. 7, the user interface 138 displays various singles, songs, Eps (Extended Plays), and albums 140a, 140b, 140c, 140d for the artist. Each of the albums 140a-140d can be selected to played. The user interface 138 can also include a lower navigation 142 that includes a plurality of buttons 144-152, which can be any combination of a home button, notification button/alert, search button, user library button, and profile selector button.

FIG. 8 is a screenshot of the user interface 138 displaying a single from an artist's music library. The user interface 138 can show single artwork 154, the single title 156, the artist name 158 associated with that single, the single title again 160, and a comment section 162 that allows users/administrators to post public comments regarding the single. The user interface also includes a credits icon 164 for the single. Any user or administrator can select or click on the credits icon 164 to bring up a credits screen for this single.

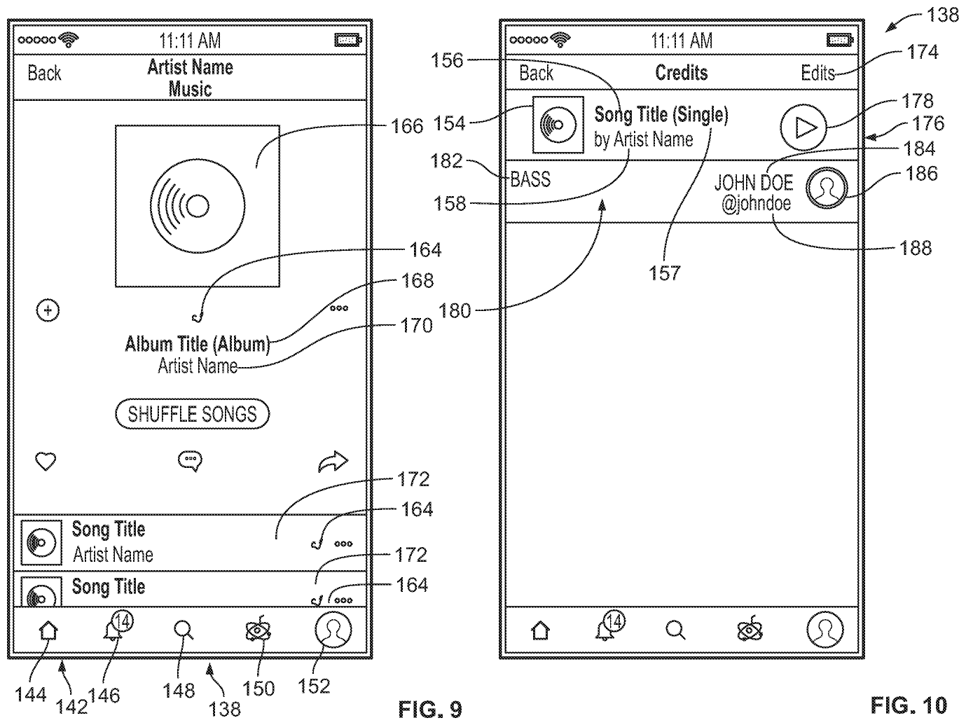

FIG. 9 is a screenshot of the user interface 138 displaying an album from an artist's music library. The user interface can show the album artwork 166, the album title 168, the artist name 170 associated with that album, and the album songs 172. The user interface also includes the credits icon 164 for the album itself and for each song on the album that is visible. Any user or administrator can select or click on the credits icon 164 to bring up a credits screen for the associated song or album.

FIGS. 10-40 are screenshots of the user interface 138 illustrating procedures of the present disclosure for an administrator of the musical work to issue an electronic credit invitation for a single, song, or album.

FIG. 10 is a screenshot of the user interface 138 displaying a credits screen for a single after the single's administrator selected or clicked on the credits icon 164 for the single shown in FIG. 8. The musical work administrator's credits screen for a single includes an edit button 174, a song bar 176 listing the single title 156, the music type designation 157 (e.g., single), and the artist name 158, a play button 178 to play the single, and a credit listing 180. The credit listing 180 includes the category 182 of credit for the single, e.g., bass, the credited profile's name 184, the credited profile picture 186, and the credited profile's username 188.

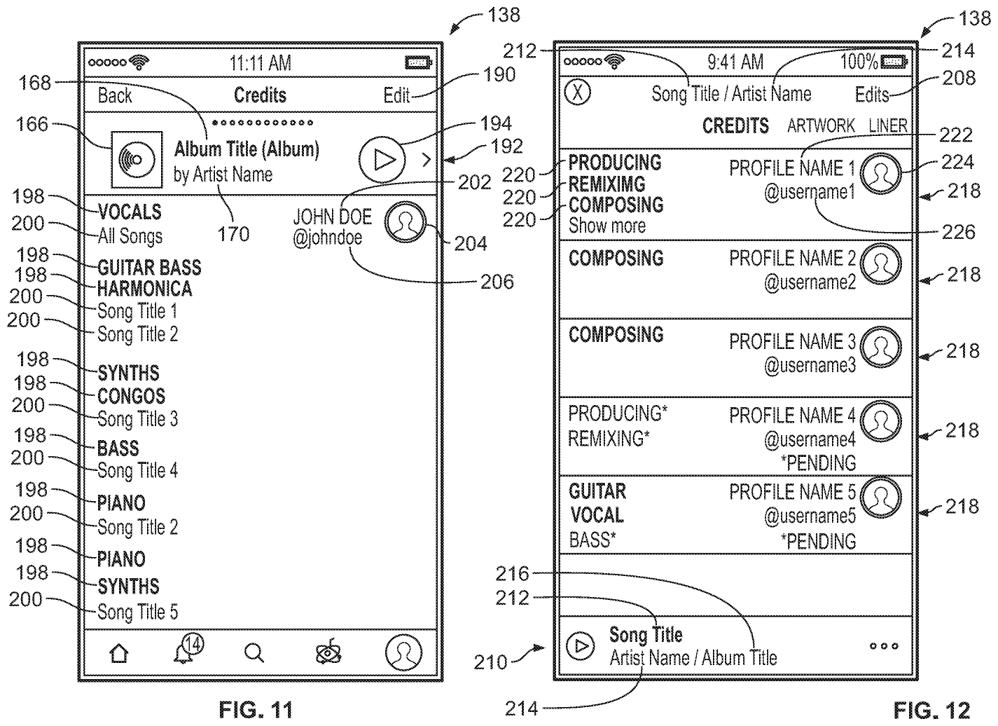

FIG. 11 is a screenshot of the user interface 138 displaying a credits screen for an album after the album's administrator selected or clicked on the credits icon 164 for the album shown in FIG. 9. The musical work administrator's credits screen for an album includes an edit button 190, a song bar 192 listing the album title 168, the music type designation (e.g., album), and the artist name 170 associated with that album, a play button 194 to play the album, and a credit listing 196. The credit listing 196 includes each credit category 198 for the album, e.g., vocals, guitar, bass, harmonica, synths, congas, piano, etc., each song 200 for which there is a credit corresponding to the relevant credit category 198, the credited profile's name 202, the credited profile picture 204, and the credited profile's username 206.

The credits screen for a single or song can also be accessed by the single or song's administrator while the single or song is playing through the music player. FIG. 12 is a screenshot of the user interface 138 displaying a musical work administrator's credits screen for a song playing through the music player. The musical work administrator's credits screen in the music player includes an edit button 208, a song bar 210 listing the song title 212, artist name 214 associated with that song, and album title 216, and credited profiles 218 for the song being played. Each credited profile 218 includes the credit category 220, credited profile's name 222, credited profile's picture 224, and profile's username 226.

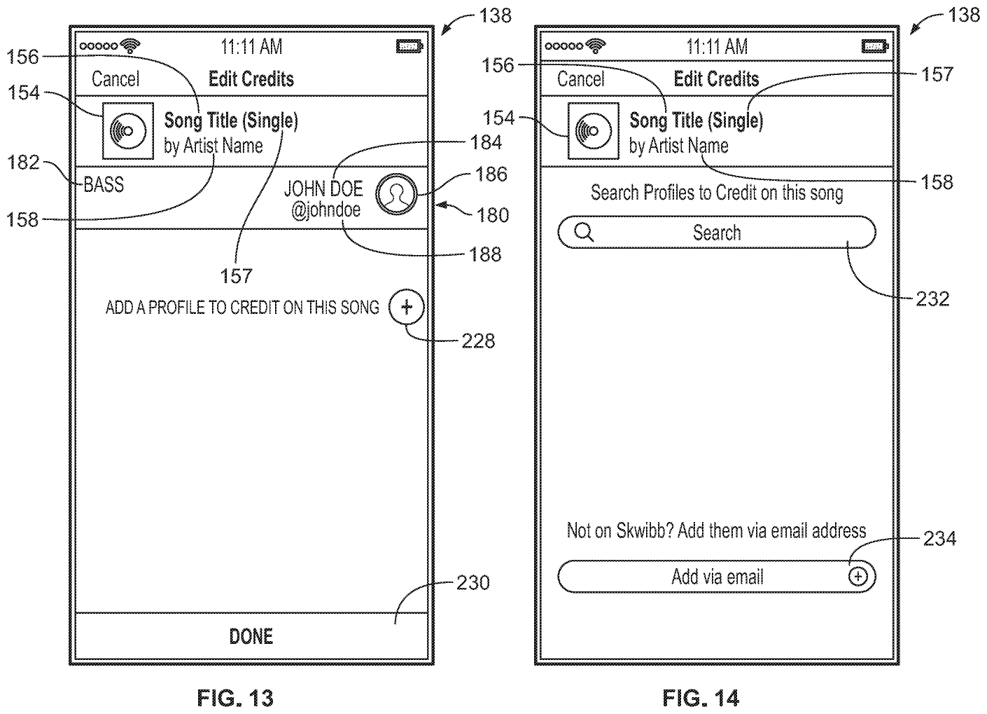

FIG. 13 is a screenshot of the user interface 138 displaying a musical work administrator's edit credits screen for a single. That is, the screen shown in FIG. 13 is displayed after the administrator for the single clicks the edit button 174 from FIG. 10. The musical work administrator's edit credits screen shows the single title 156 and artist name 158 associated with that single, the existing credit listing 180 for the single including the category 182 of credit for the single, the credited profile's name 184, the credited profile picture 186, and the credited profile's username 188, an add profile to credit button 228, and a done button 230. The add profile to credit button 228 can be selected or clicked on to display a profile search screen, and the done button 230 can be selected or clicked on to exit the edit credits screen.

FIG. 14 is a screenshot of the user inter face 138 displaying a profile search screen that is displayed after the musical work administrator clicks the add profile to credit button 228. The profile search screen shows the single title 156, music type designation 157, and artist name 158 for the single for which credit is being added, a profile search bar 232, and an “invite via email” text input field 234. The musical work administrator can input the profile or user name that he or she desires to credit into the profile search bar 232, which will search the database 16 for matching profile names or usernames, and display a list of the search results. If the profile that the musical work administrator is looking to credit is not in the database, then the musical work administrator can select or click on the invitation bar 234 to send an e-mail to a non-user that includes the credit invitation.

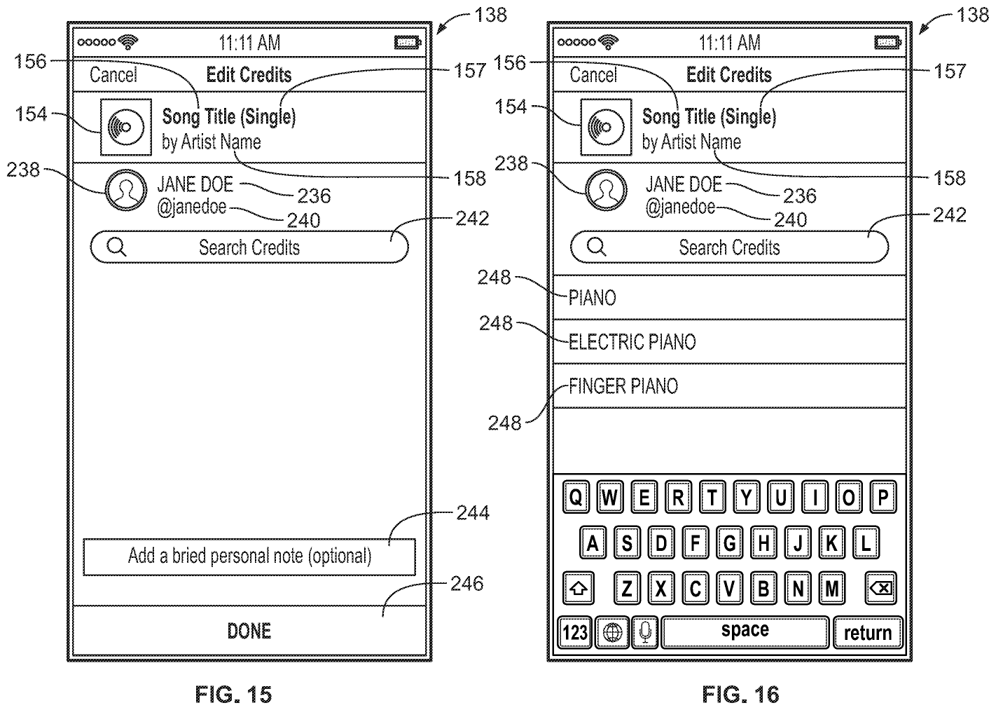

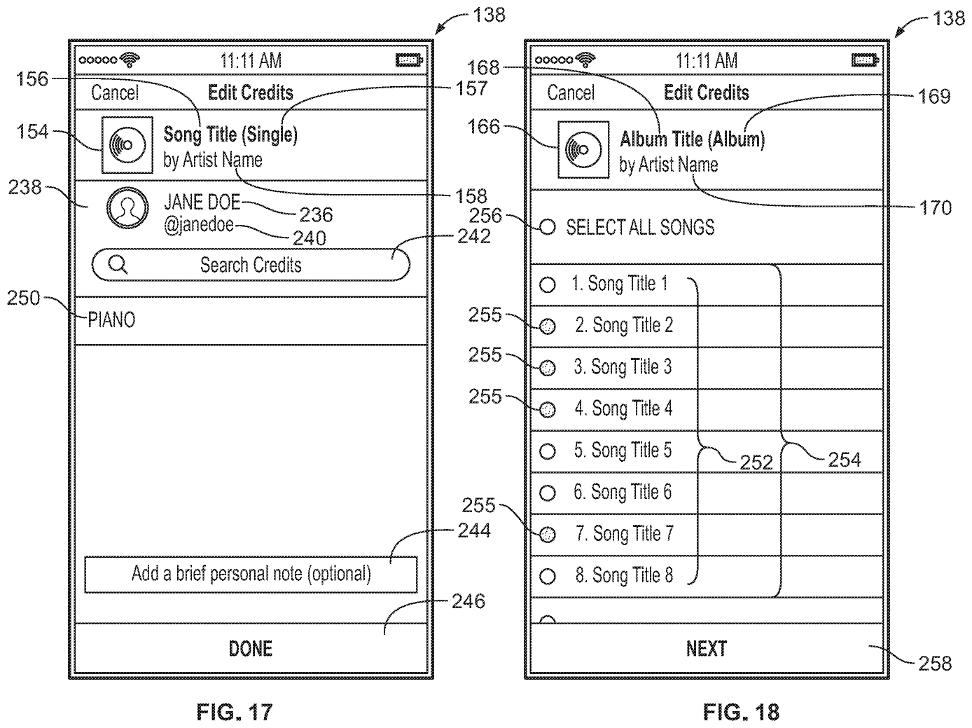

Once the profile to be credited is found, the musical work administrator can search for categories to be credited to that profile for the specific single. FIG. 15 is a screenshot of the user interface 138 displaying a credit category search screen that is displayed after the single's administrator has selected the profile from the profile search screen shown in FIG. 14. The credit category search screen shows the single title 156, music type designation 157, and artist name 158 for the single for which credit is being added, the profile's name 236 for which credit is being invited, profile picture 238, and username of the profile to be credited 240, a credit category search bar 242, an add a note button 244, and a done button 246. The add a note button 244 can be selected to add a note to the credit invitation that is ultimately sent to the profile for which the musical work administrator is adding the credit. The musical work administrator can input the credit category that he or she is looking to credit to the selected profile in the credit category search bar 242, which will display a list of potential credit categories 248, as shown in FIG. 16, which is a screenshot of the user interface 138 showing the credit category search screen with a plurality of potential credit categories 248 listed. This can be in the form of a drop down list from which the musical work administrator can select the desired credit categories. For example, in FIG. 16, the musical work administrator input “Piano” into the credit category search bar 242, which brought up three potential credit categories 248, e.g., “Piano,” “Electric Piano,” and “Finger Piano.” The musical work administrator can click on one of the potential credit categories 248 from the drop down menu, which will add a desired credit category 250 to the credit category search screen, as shown in FIG. 17. The administrator can continue this process until all of the desired credit categories have been added. Once completed, the administrator can select or click on the done button 246.

If the musical work administrator was adding credits for an album, then after clicking the done button 246 the user interface would display a select songs screen as shown in FIG. 18, which is a screenshot of the user interface 138 showing a select songs screen for an album credit. The select songs screen shows the album title 168, the artist name 170 associated with that album, a song listing 252 that lists all songs from the album, a plurality of buttons 254 each corresponding to a single song, an all songs button 256, and a next button 258. The musical work administrator can select each song he or she would like to send an electronic credit invitation for by clicking on the appropriate buttons 255 corresponding to the desired songs. If all of the songs on the album are to be credited then the musical work administrator can click on the all songs button 256. Once the desired songs are selected the musical work administrator can click the next button 258 to proceed to an electronic credit invitation review screen to finalize the credit invitation.

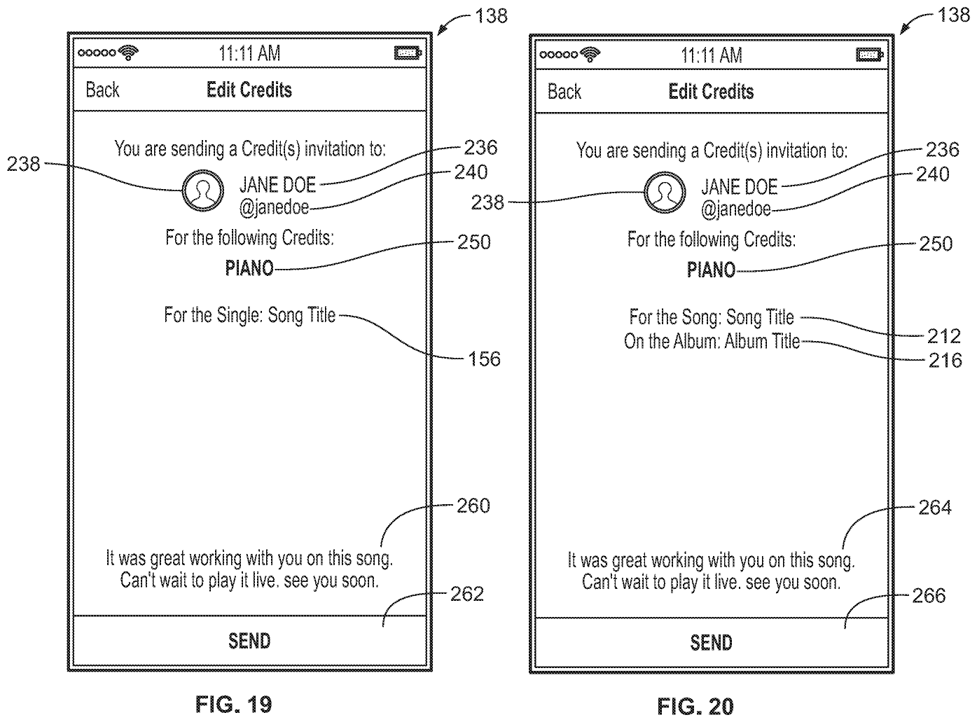

FIG. 19 is a screenshot of the user interface 138 displaying a musical work administrator's credit invitation review screen for a musical work classified as a single. The musical work administrator credit invitation review screen displays the profile's name for which credit is being invited 236, the same profile's picture 238, and the same profile's username 240, the previously chosen desired credit category 250, the single title 156, a personal message 260 if one was entered, and a send button 262. The musical work administrator can review the details of the credit invitation on the credit invitation review screen, and if everything is correct click the send button 262 to confirm the accuracy.

FIG. 20 is a screenshot of the user interface 138 displaying a musical work administrator's credit invitation review screen for a musical work classified as a song from an album. The musical work administrator's credit invitation review screen displays the profile's name for which credit is being invited 236, the same profile's picture 238, and the same profile's username 240, the previously chosen desired credit category 250, the song title 212, the album title 216, a personal message 264 if one was entered, and a send button 266. The musical work administrator can review the details of the credit invitation on the credit invitation review screen, and if everything is correct click the send button 266 to confirm the accuracy.

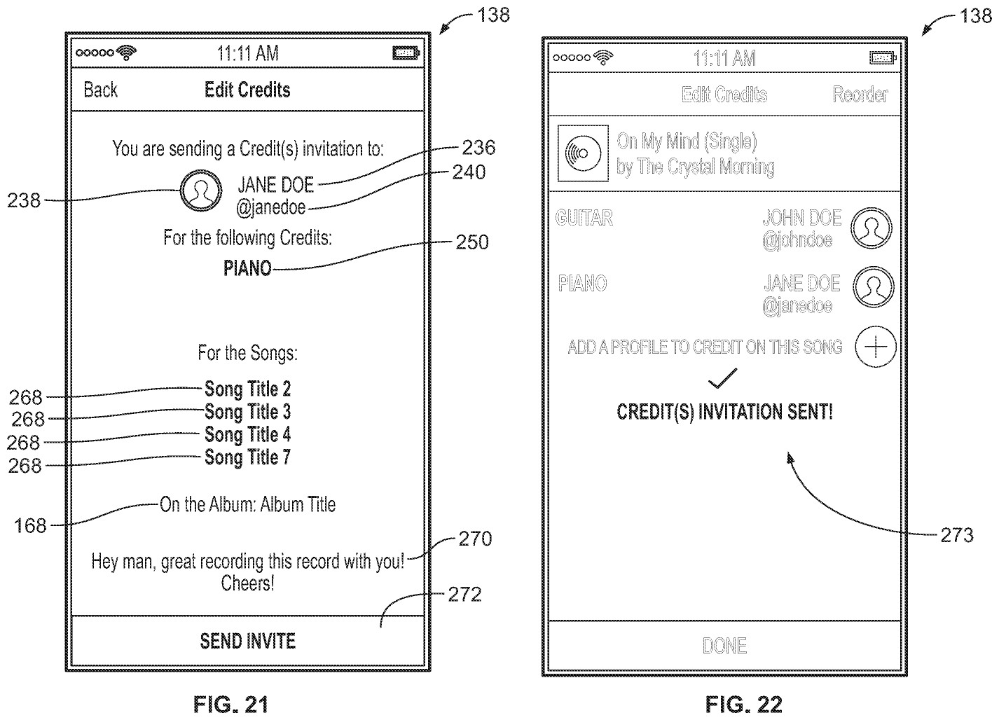

FIG. 21 is a screenshot of the user interface 138 displaying a musical work administrator's credit invitation review screen for a musical work classified as an album. The musical work administrator's credit invitation review screen displays the profile's name for which credit is being invited 236, the same profile's picture 238, and the same profile's username 240, the previously chosen desired credit category 250, the song titles previously selected 212, the album title 216, a personal message 270 if one was entered, and a send button 272. The musical work administrator can review the details of the credit invitation on the credit invitation review screen, and if everything is correct click the send button 272 to confirm the accuracy.

FIG. 22 is a screenshot of the user interface 138 displaying a confirmation pop-up 273 that is displayed to the musical work administrator after he or she clicks one of the send buttons 262, 266, 272 in the review screens shown in FIGS. 19-21.

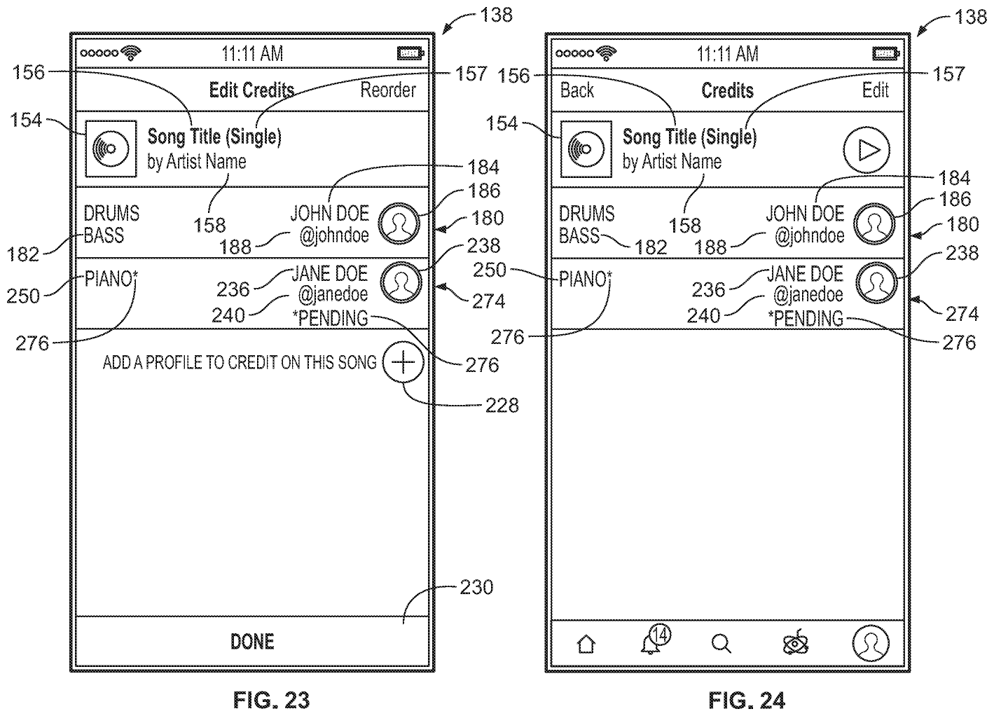

FIG. 23 is a screenshot of the user interface 138 displaying the edit credits screen after the musical work administrator has sent an electronic credit invitation for a single. As can be seen in FIG. 23, a pending credit listing 274 is added, which includes the details of the musical work administrator's previously sent credit invitation. Specifically, the pending credit listing 274 includes the invited profile's name 236, profile picture 238, and profile's username 240 to be credited, and the desired credit category 250. Two pending icons 276 are also placed in the pending credit listing 274. The pending credit listing 274 can also be displayed in a different color font or grayed out font to indicate that it is pending and not authenticated yet. While on the edit credits screen, the musical work administrator can add more profiles to credit, or edit existing credits for an existing credited profile. If the musical work administrator is done adding credits to this single, he or she can click the done button 230, which returns the musical work administrator to the musical work administrator's credits screen.

FIG. 24 is a screenshot of the user interface 138 displaying the musical work administrator's music credits screen for a single with the newly added pending credit displayed. Pending credit invitations can be visible to all users on the music credits screens.

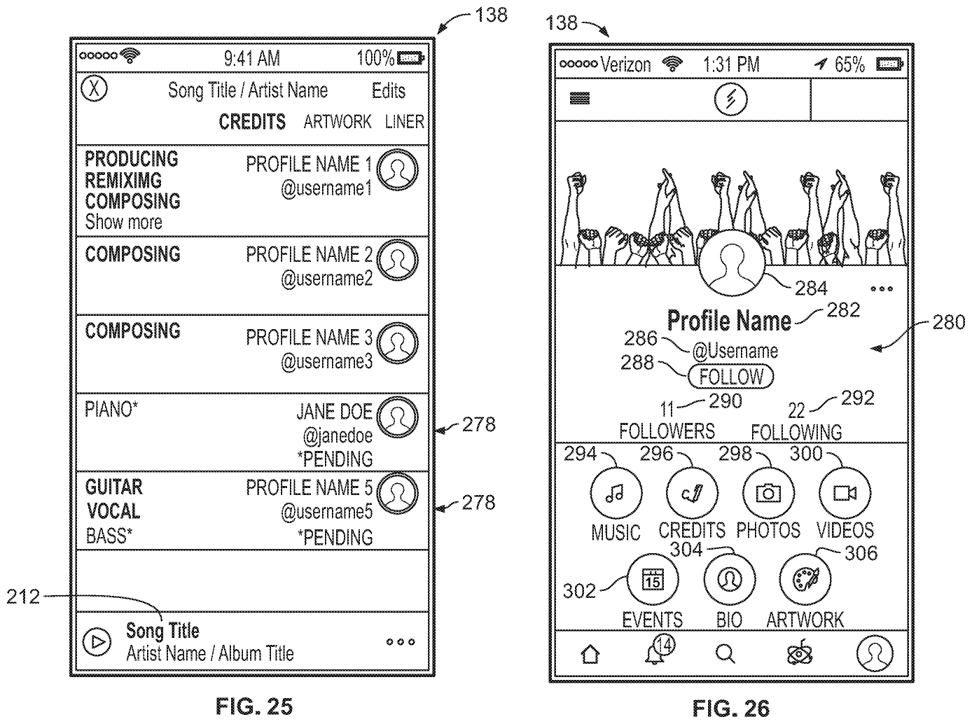

FIG. 25 is a screenshot of the user interface 138 displaying the musical work administrator's credits screen for a song playing through the music player. Pending credit invitations 278 for a song can be visible to all users in the music player while the song is playing.

FIG. 26 is a screenshot of the user interface 138 displaying a profile 280. The profile 280 can include various information regarding the profile including the profile name 282, profile picture 284, and profile's username 286. The profile 280 can also have a follow button 288 that allows other profiles to follow this profile, and can also show the profile's number of followers 290 and number of other profiles the profile is following 292. The profile 280 can also include a music button 294, a credits button 296, a photos button 298, a videos button 300, an events button 302, a bio button 304, an artwork button 306, a lyrics button (not shown), a public playlists button (not shown), and a public likes button (not shown). Users can tap the credits button 296 in a profile 280 to access the credits screen for that profile 280.

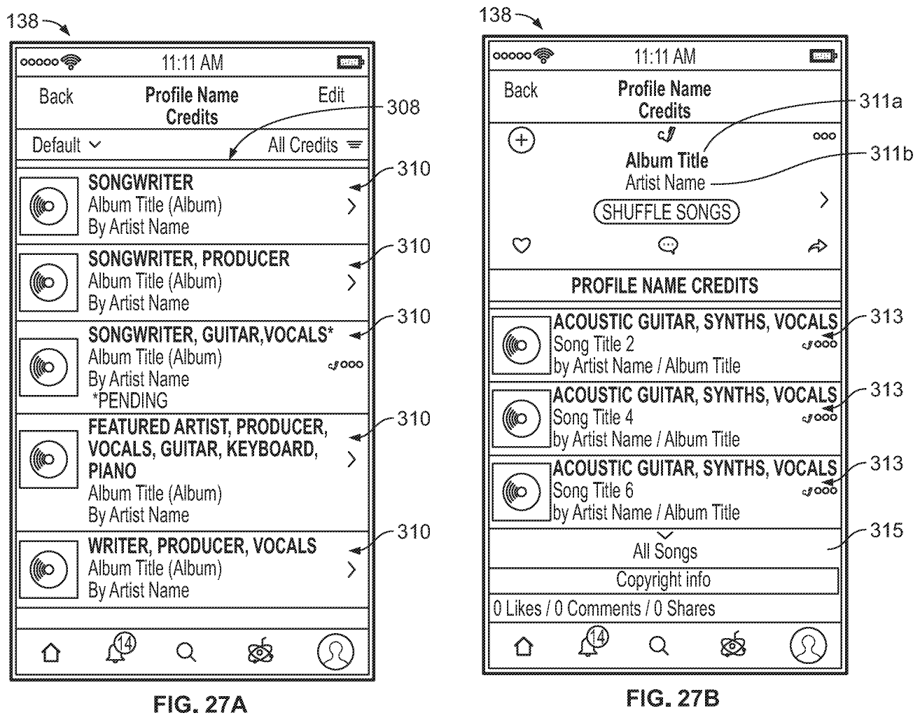

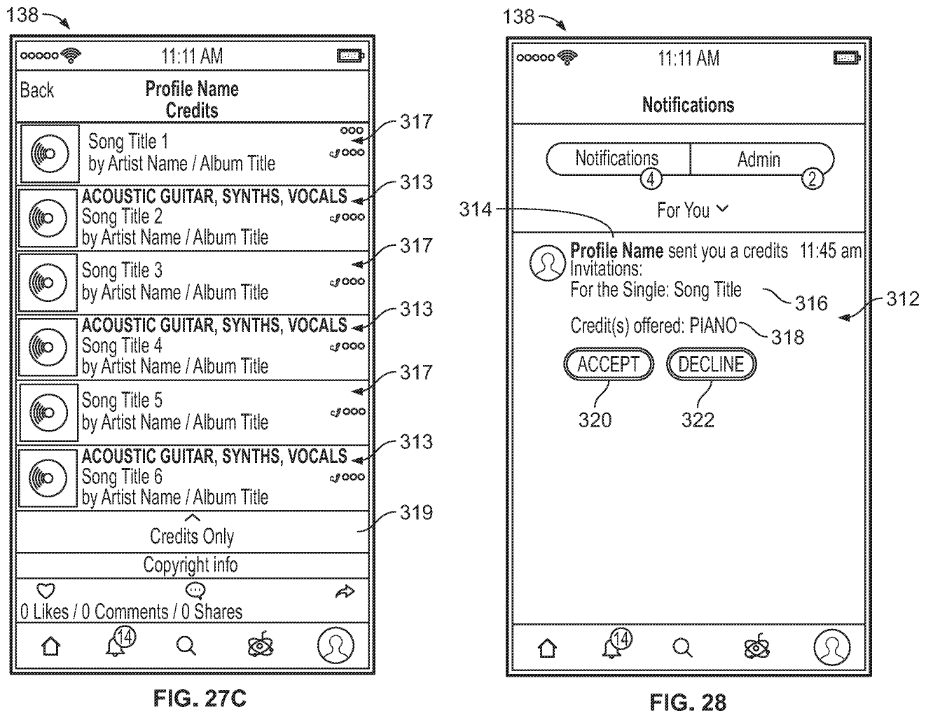

FIG. 27A is a screenshot of the user interface 138 displaying a credits screen 308 for a profile. The credits screen 308 shows all authenticated credits and pending credit requests 310 for that profile, and will list the details of those credits. For example, each credit 310 can list the single, album, artist name associated with that single or album, and credit category for the credit, where appropriate. In some aspects, only authenticated credits and pending credit requests are shown in the credits screen 308, while credit invitations are not shown. For an album credit, a user can click on the credit 310, which will cause the user interface to parse out and display each individual credit per song of that album for which the profile has an authenticated credit or pending credit request, as shown in FIG. 27B. Specifically, FIG. 27B is a screenshot of the user interface 138 displaying a credits screen for a profile for a specific album that has been selected. When the user clicks on an album credit 310, the user interface will display the album title 311a and the artist name 311b for the album for which credit is being given, along with each individual credited song 313 on the album for which the profile has an authenticated credit or a pending credit request. For each credited song 313, the credit category for which the profile is credited is listed. The user interface also includes an all songs button 315, which can be pressed to display a listing of all of the songs from this album, including those that the profile is not listed on, as shown in FIG. 27C. Specifically, FIG. 27C is a screenshot of the user interface 138 displaying a credits screen for a profile for a specific album that has been selected after the user presses the all songs button 315. After a user presses the all songs button 315 the user interface 138 will display not only the credited songs 313 from the selected album, but will also list the non-credited songs 317 from the selected album. A credits only button 319 is also displayed that when clicked will reduce the album songs being listed to only those for which the profile is credited, e.g., the screen shown in FIG. 27B. Additionally, administrators of this profile can access the profile's credits screen 308 and swipe left on any credit to edit the credit, hide the credit, or delete the credit.

FIG. 28 is a screenshot of the user interface 138 displaying an electronic credit invitation message 312 for a single. After an administrator of a musical work submits an electronic credit invitation, as detailed above, the credit invitation message 312 is sent to the administrators of the profile being credited, e.g., from the authentication engine 18. The credit invitation message 312 for a single includes the artist name associated with the musical work being credited 314, the single name 316, and the credit category 318. The credit invitation message 312 also includes an accept button 320 and a decline button 322. In the case of a song credit, as opposed to a single credit, the album title would also be listed in the credit invitation message 312. If the administrator of the invited profile wishes to accept the credit invitation on behalf of that profile then he or she can click the accept button 320, which can notify the authentication engine 18 of the profile's acceptance. The authentication engine 18 will in turn authenticate the credit and update the database 16 accordingly. If the administrator of the invited profile does not wish to accept the credit invitation then he or she clicks the decline button 322, which can notify the authentication engine 18 of the profile's declination. The authentication engine 18 will in turn not authenticate the credit and will update the database 16 accordingly, e.g., remove the pending credit.

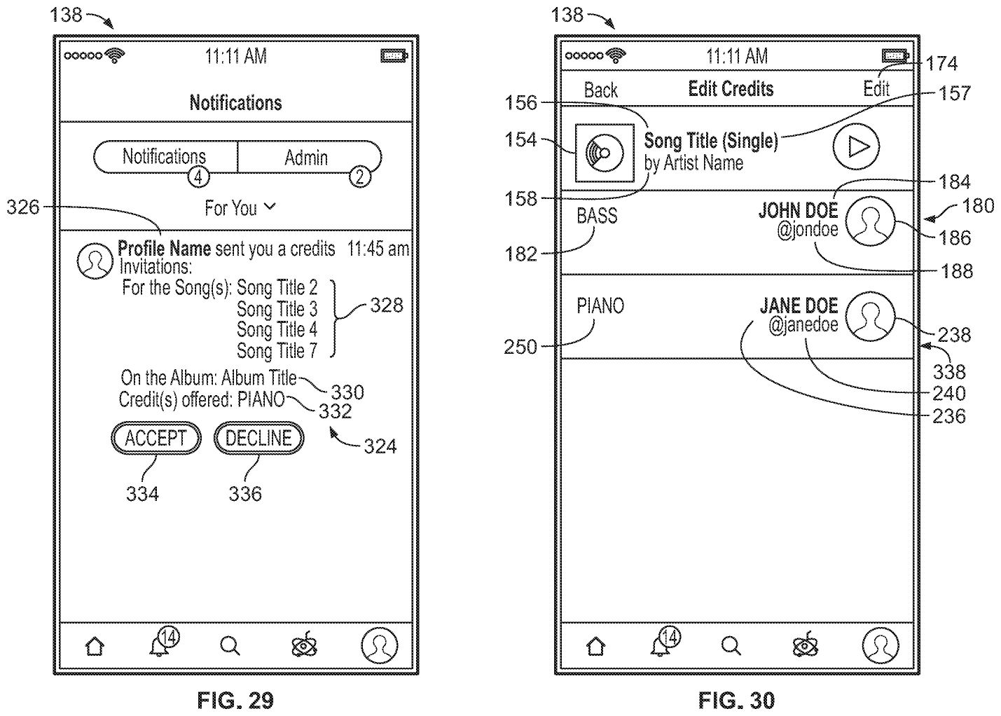

FIG. 29 is a screenshot of the user interface 138 displaying an electronic credit invitation message 324 for an album. After an administrator of a musical work submits an electronic credit invitation, as detailed above, the credit invitation message 324 is sent to the administrators of the invited profile, e.g., from the authentication engine 18. The credit invitation message 324 for an album includes the artist name associated with the musical work being credited 326, a list of the song names 328, the album title 330, and the credit category 332. The credit invitation message 324 also includes an accept button 334 and a decline button 336. If the administrator of the invited profile wishes to accept the credit invitation on behalf of that profile then he or she can click the accept button 334, which can notify the authentication engine 18 of the profile's acceptance. The authentication engine 18 will in turn authenticate the credit and update the database 16 accordingly. If the administrator of the invited profile does not wish to accept the credit invitation, then he or she clicks the decline button 336, which can notify the authentication engine 18 of the profile's declination. The authentication engine 18 will in turn not authenticate the credit and will update the database 16 accordingly, e.g., remove the pending credit.

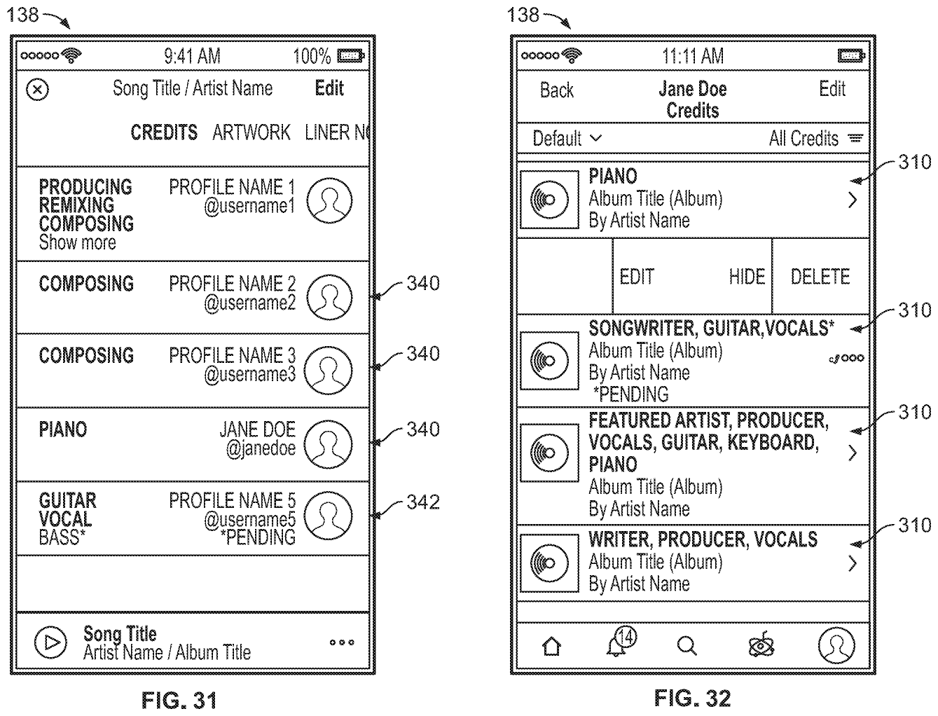

FIG. 30 is a screenshot of the user interface 138 displaying the musical work administrator's music credits screen of FIG. 24 after the invited profile has accepted the pending credit and the credit has been authorized. As can be seen in FIG. 30, the previously pending credit listing 274 has turned into an authenticated credit listing 338 with the pending icons 276 removed. The authenticated credit listing 338 includes the credited profile's name 236, profile picture 238, profile's username 240, and the credit category 250 previously displayed in the pending credit listing 274. The profile credited in the credit listing 338 can be for a single music industry professional profile, or for a group profile which can be made up of multiple profiles, e.g., for a horn section, production team, record company, recording studio, master facility, etc. Authenticated credits can be shown in three different places: the music credits screen (see FIG. 30), the music player (see FIG. 31), and the profile's credit screen (see FIG. 32).

FIG. 31 is a screenshot of the user interface 138 displaying a musical work administrator's credits screen for a song being played through the music player. As can be seen in FIG. 31, both authenticated credits 340 and pending credits 342 can be displayed. In some aspects, pending credit invitations are shown to all users, whereas pending credit requests are shown only to the administrators of the requesting profile.

FIG. 32 is a screenshot of the user interface 138 displaying the credits screen 308 for a profile. As can be seen in FIG. 32, the credits screen 308 shows and displays all authenticated credits and pending credit requests 310 for that profile to any other profile accessing the credited profile. For example, each credit 310 lists the single, album, artist, and credit category for the credit, where appropriate. In some aspects, only authenticated credits and pending credit requests are shown in the credits screen 308, while credit invitations are not shown. For an album credit, a user can click on the credit 310, which will cause the user interface to parse out and display each individual credit per song of that album for which the profile has an authenticated credit or pending credit request, as shown and described in connection with FIG. 27B, the functionality of which is incorporated herein. A user can also press the all songs button 315 of FIG. 27B to display not only the credited songs 313 from the selected album, but to also list the non-credited songs 317 from the selected album, as shown and described in connection with FIG. 27C, the functionality of which is incorporated herein. Additionally, administrators of this profile can access the profile's credits screen 308 and swipe left on any credit to edit the credit, hide the credit, or delete the credit.

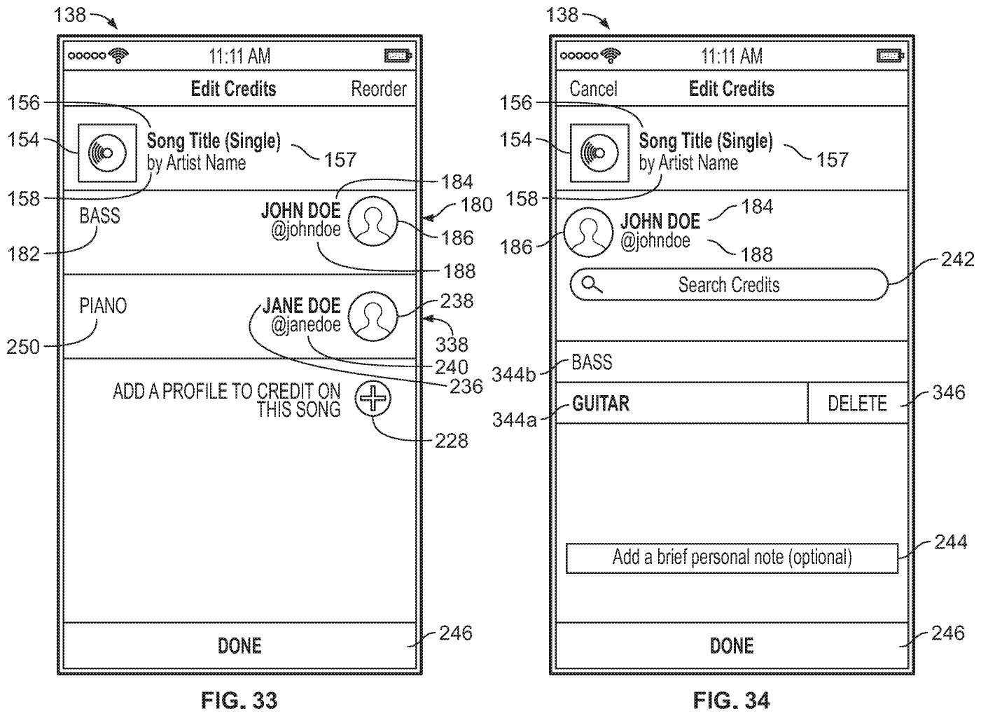

FIG. 33 is a screenshot of the user interface 138 displaying the musical work administrator's edit credits screen for a single as shown in FIG. 23, but after the pending credit has been authenticated for the single. This screen can be accessed, for example, by selecting or click on the edit button 174. A musical work administrator can send a credits invitation to a profile that already has an authenticated or pending credit from the edit credits screen by selecting the profile, e.g., clicking on the credit listing 180, 338, the credited profile's name 184, 236, the credited profile picture 186, 238, or anywhere in the profile field, e.g., on the profile's username 188, 240.

FIG. 34 is a screenshot of the user interface 138 displaying a musical work administrator's edit credits screen for a specific profile in connection with a single that is displayed after the musical work administrator has selected the profile from the edit credits screen shown in FIG. 33 for that single. The edit profile credits screen shows the single title 156, music type designation 157 (e.g., single) and artist name 158 for the single for which credit is being given, the profile's name 184, profile picture 186, and credited profile's username 188, the credit category search bar 242 (see also FIG. 15), the add a note button 244, and the done button 246. The edit profile credits screen for a single can also include a listing of each authorized or pending credit 344a, 344b for the selected profile. While in the edit profile credits screen, the musical work administrator can use the credit category search bar 242 to search for additional credits to send the profile an invitation for or can edit the credits 344a, 344b (both authorized and pending) for that profile. For example, the musical work administrator can swipe, e.g., left, on one or more of the profile's credits 344a, 344b to display a delete button 346 for that credit 344a. Similar functionality can also be performed for a credit applied to individual songs as well as individual songs of an album.

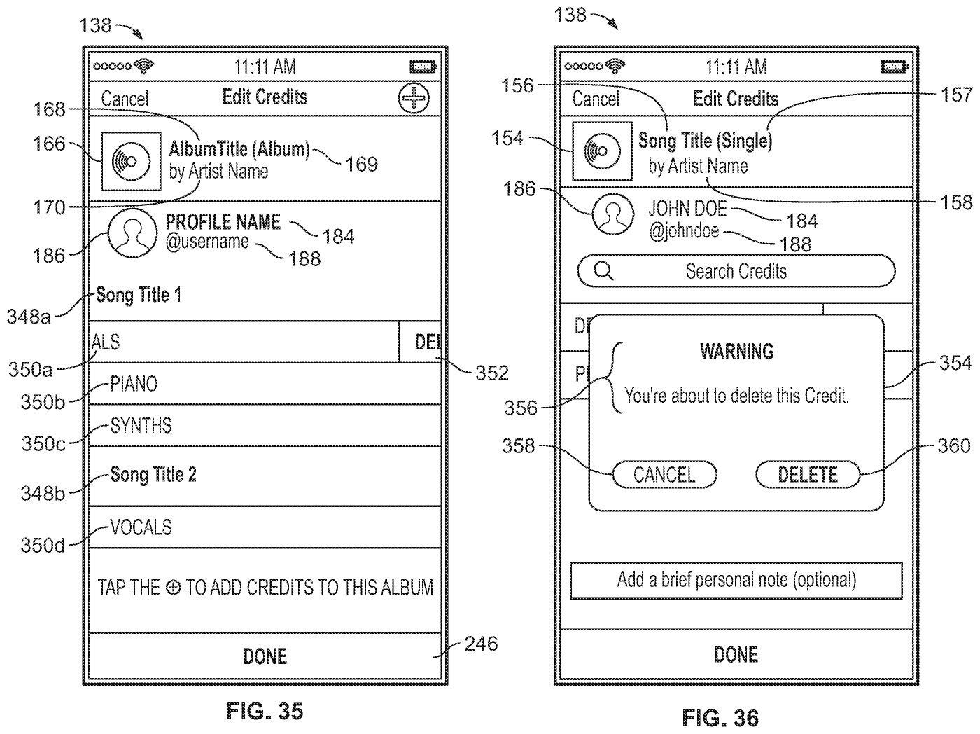

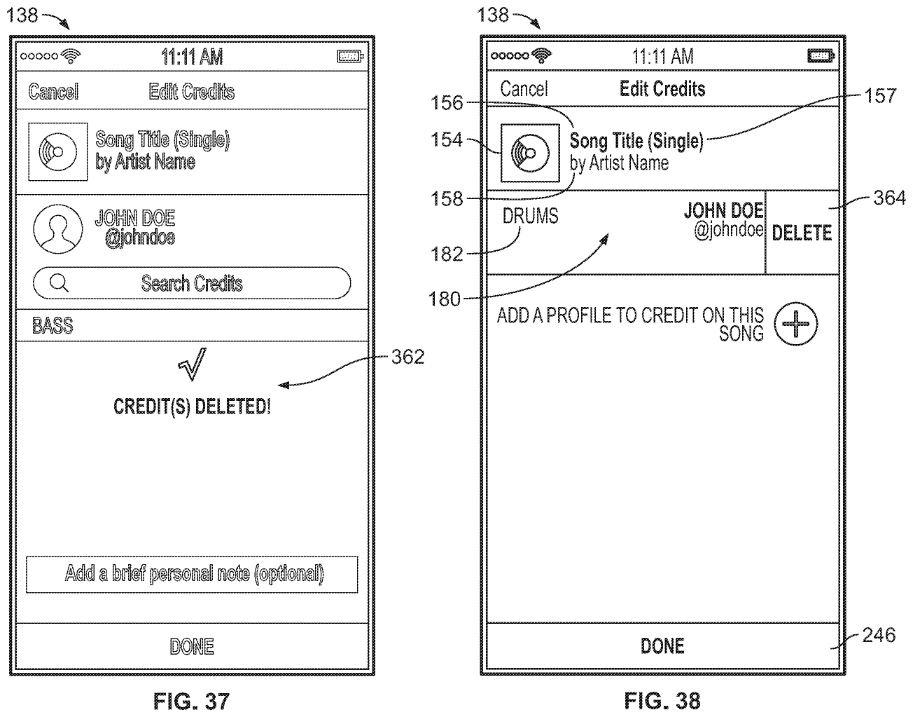

FIG. 35 is a screenshot of the user interface 138 showing a musical work administrator's edit credits screen for a specific profile in connection with an album that is displayed after the musical work administrator of the album has selected the profile from the edit credits screen for that album. The edit profile credits screen shows the album title 168 and artist name 170 for the album for which credit is being given, the credited profile's name 184, credited profile's picture 186, and credited profile's username 188, and the done button 246. The edit profile credits screen for an album can also display each song 348a, 348b that the profile is credited on along with the profile's credits 350a, 350b, 350c, 350d, e.g., categories, for each song 348a, 348b. While in the edit profile credits screen, a musical work administrator can edit any of the listed credits 350a-350d (both authorized and pending) for that profile. For example, the musical work administrator can swipe, e.g., left, on one or more of the profile's credits 350a-350d to display a delete button 352 for that credit 350a. If the musical work administrator selects or presses either of the delete buttons 346, 352 from the edit profile credits screens for a profile, a warning popup 354 is displayed to the musical work administrator, as shown in FIG. 36, which is a screenshot of the user interface 138 showing the warning popup 354 after a musical work administrator has chosen to delete a credit from a profile. The warning popup 354 includes a warning message 356 for the musical work administrator, which generally warns the musical work administrator that he or she is about to delete a credit, along with a cancel button 358 and a delete button 360. If the musical work administrator selects the cancel button 358, then he or she will return back to the edit profile credits screen shown in FIGS. 34 and 35, or back to a home screen. If the musical work administrator selects the delete button 360, then the credit is deleted from the profile, and the database 16 is updated by the authentication engine 18. Furthermore, after a musical work administrator successfully deletes a credit from a profile, a confirmation pop-up 362 is displayed, as shown in FIG. 37, which is a screenshot of the user interface 138 showing the confirmation pop-up 362 after a musical work administrator has successfully deleted a credit from a profile. The confirmation pop-up 362 will automatically disappear and return the user to the musical work administrator's edit profile credits screen.

FIG. 38 is a screenshot of the user interface 138 showing the musical work administrator's edit credits screen for a single, similar to that of FIG. 33. In addition to the functionality discussed in connection with FIG. 33, when a musical work administrator is in the edit credits screen for a single, song, or album, the musical work administrator can delete an entire credited profile 180 for that single, song, or album. For example, the musical work administrator can swipe, e.g., left, on the credited profile 180, which can be an authenticated credited profile or a pending credit profile, to bring up a delete button 364.

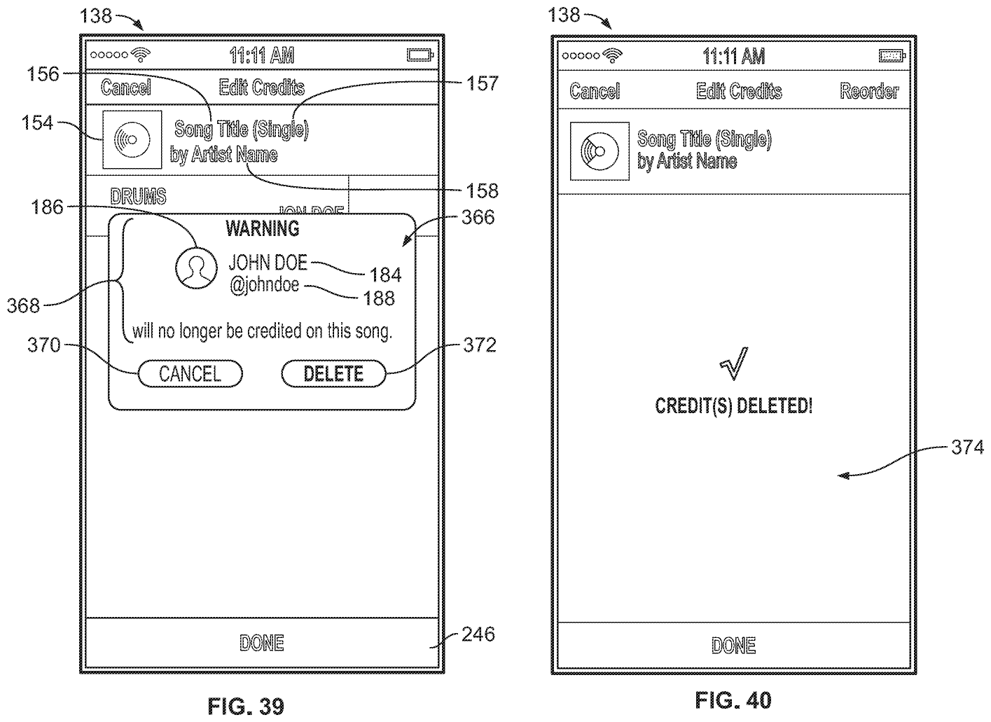

If the musical work administrator selects or presses the delete button 364, a warning popup 366 is displayed to the administrator, as shown in FIG. 39, which is a screenshot of the user interface 138 showing the warning popup 366 after a musical work administrator has chosen to delete a credited profile 180 from a single, song, or album. The warning popup 366 includes a warning message 368 for the administrator, which generally warns the administrator about deleting a credited profile and lists the profile's information including the credited profile's name 184, the credited profile's picture 186, and the credited profile's username 188, along with a cancel button 370 and a delete button 372. In the case of an album, the message would read “Profile Name will no longer be credited on this Album.” If the musical work administrator selects the cancel button 370, then the administrator will be returned back to the edit credits screen shown in FIG. 38. If the musical work administrator selects the delete button 372, then the credited profile is deleted from the single, song, or album, and the database 16 is updated by the authentication engine 18. Furthermore, after a musical work administrator successfully deletes a credited a profile from a single, song, or album, a confirmation pop-up 374 is displayed, as shown in FIG. 40, which is a screenshot of the user interface 138 showing the confirmation pop-up 374 after a musical work administrator has successfully deleted a credited profile from a single, song, or album.

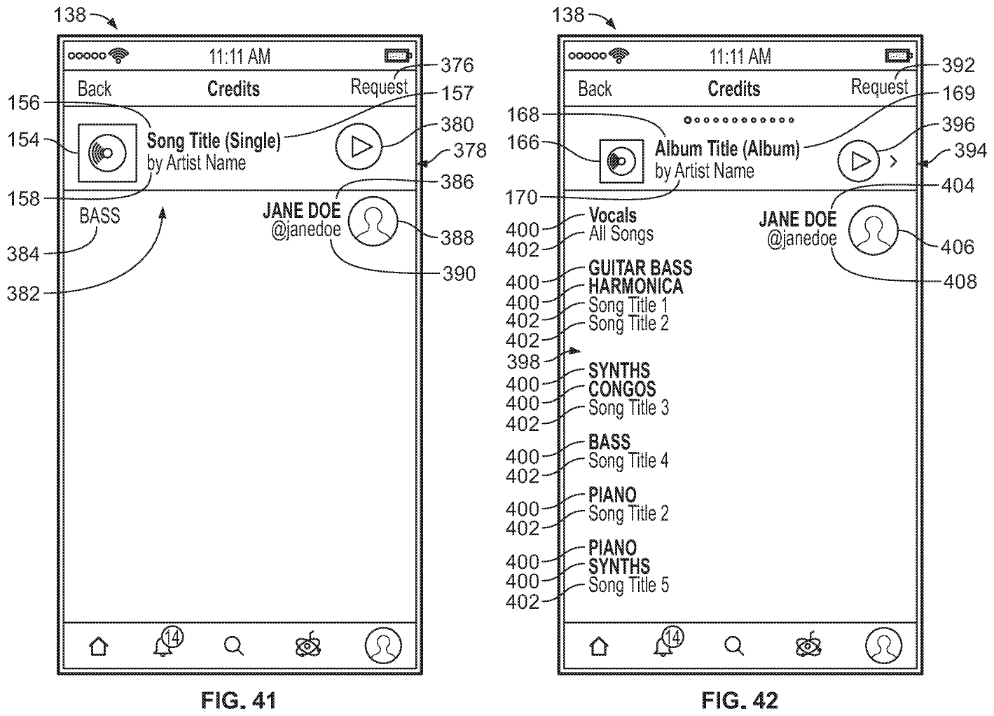

FIGS. 41-66 are screenshots of the user interface illustrating procedures of the present disclosure for an administrator of a profile to request credits on behalf of a profile for a single, song, or album. As referenced above, FIG. 7 is a screenshot of the user interface 138 of the present disclosure displayed on a musical work administrator's smart device 20 or a user's smart device 22, and displaying an artist's music library. The user interface 138 can also be displayed on a musical work administrator's computer 24 or a user's computer 26. FIG. 8 is a screenshot of the user interface 138 displaying a single from the artist's music library, and the user can select or click on the credits icon 164 to bring up a credits screen for that single. FIG. 9 is a screenshot of the user interface 138 displaying an album from the artist's music library, and the user can select or click on the credits icon 164 to bring up a credits screen for that album.

FIG. 41 is a screenshot of the user interface 138 displaying a musical work non-administrator's credits screen for a single after the non-administrator selected or clicked on the credits icon 164 for the single shown in FIG. 8. The non-administrator's credits screen for a single includes a request button 376, a song bar 378 listing the single title 156, the music type designation 157 (e.g., single), and artist name 158 associated with the song or single, a play button 380 to play the single, and a credit listing 382. The credit listing 382 includes the category 384 of credit for the single, e.g., bass, the credited profile's name 386, the credited profile's picture 388, and the credited profile's username 390.

FIG. 42 is a screenshot of the user interface 138 showing a musical work non-administrator's credits screen for an album after the non-administrator selected or clicked on the credits icon 164 for the album shown in FIG. 9. The credits screen for an album includes a request button 392, a song bar 394 listing the album title 168, the music type designation 169 (e.g., album), and artist name 170 associated with the album, a play button 396 to play the album, and a credit listing 398. The credit listing 398 includes each credit category 400 for the album, e.g., vocals, bass guitar, harmonica, synths, congas, piano, etc., each song 402 for which there is a credit corresponding to the relevant credit category, the credited profile's name 404, the credited profile's picture 406, and the credited profile's username 408.

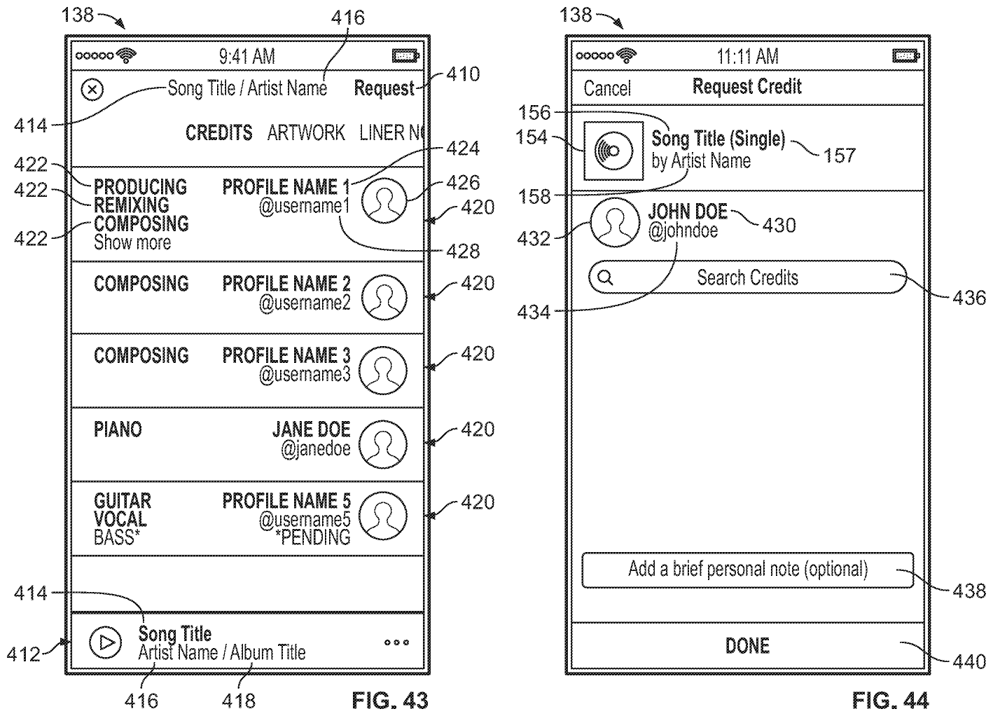

The credits screen for a single or song can also be accessed by a non-administrator of that single or song while the single or song is playing through the music player. FIG. 43 is a screenshot of the user interface 138 displaying a musical work non-administrator's credits screen for a song playing through the music player. The credits screen includes a request button 410, a song bar 412 listing the song title 414, artist name 416, and album title 418, and profile credits 420 for the song being played. Each profile credit 420 includes the credit category 422, credited profile's name 424, credited profile's picture 426, and credited profile's username 428.

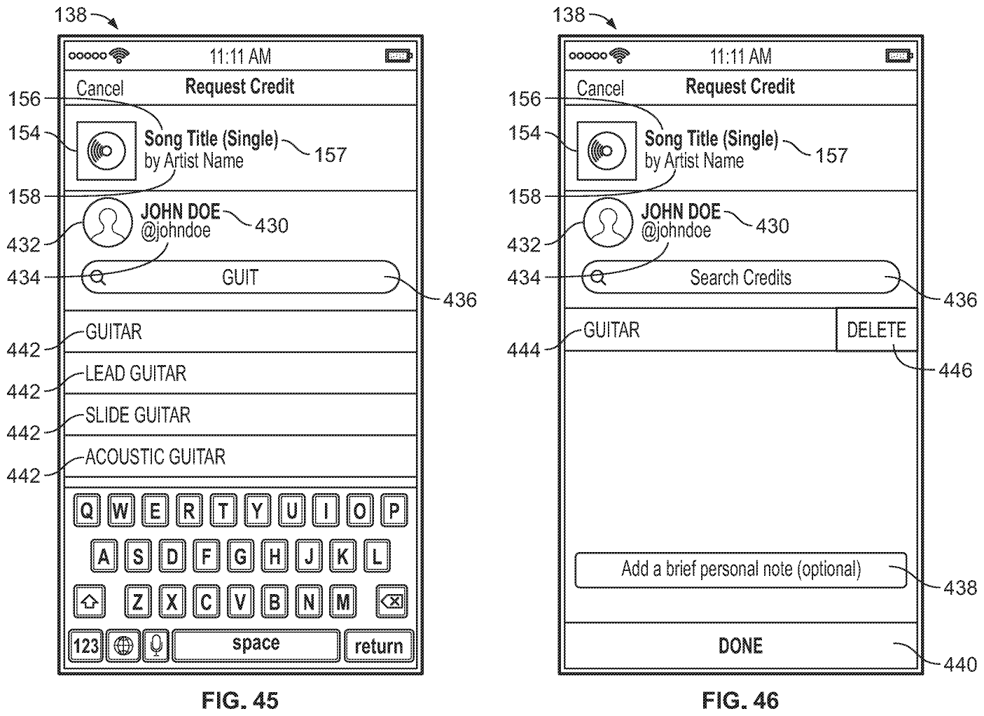

FIG. 44 is a screenshot of the user interface 138 showing a musical work non-administrator's request credit screen for a single. That is, the screen shown in FIG. 44 is displayed after the musical work non-administrator clicks the request button 376 from FIG. 41. The musical work non-administrator request credit screen shows the single title 156, the music type designation 157 (e.g., single), and artist name 158 for the single for which credit is being requested, the requesting profile's name 430, the requesting profile's picture 432, the requesting profile's username 434 (e.g., the user name, profile picture, and username of the current profile who is requesting credit for the single), a credit category search bar 436, an add a note button 438, and a done button 440. The add a note button 438 can be selected to add a note to the request that is ultimately sent to the musical work administrator for the single that the musical work non-administrator is requesting credit on. The musical work non-administrator can input the credit category that he or she is looking to request in the credit category search bar 436, which will display a list of potential credit categories 442, as shown in FIG. 45, which is a screenshot of the user interface 138 showing the profile's request credit screen with a plurality of potential credit categories 442 listed based on the user's input into the credit category search bar 436. This can be in the form of a drop down list from which the user can select the desired credit categories. For example, in FIG. 45, the user input “GUIT” into the credit category search bar 436, which brought up four potential credit categories 442, e.g., “Guitar,” “Lead Guitar,” “Slide Guitar,” and “Acoustic Guitar.” The user can click on one of the potential credit categories 442 from the drop down menu, which will add a desired credit category 444 to the user's request credit screen, as shown in FIG. 46. The user can continue this process until all of the desired credit categories have been added. Once completed, the user can select or click on the done button 440. The newly added desired credit category 444 can also be deleted if desired. Specifically, the user can delete the newly added desired credit category 444 by swiping, e.g., left, on the credit category 444, to bring up a delete button 446, which can be selected or pressed by the user to delete the desired credit category 444.

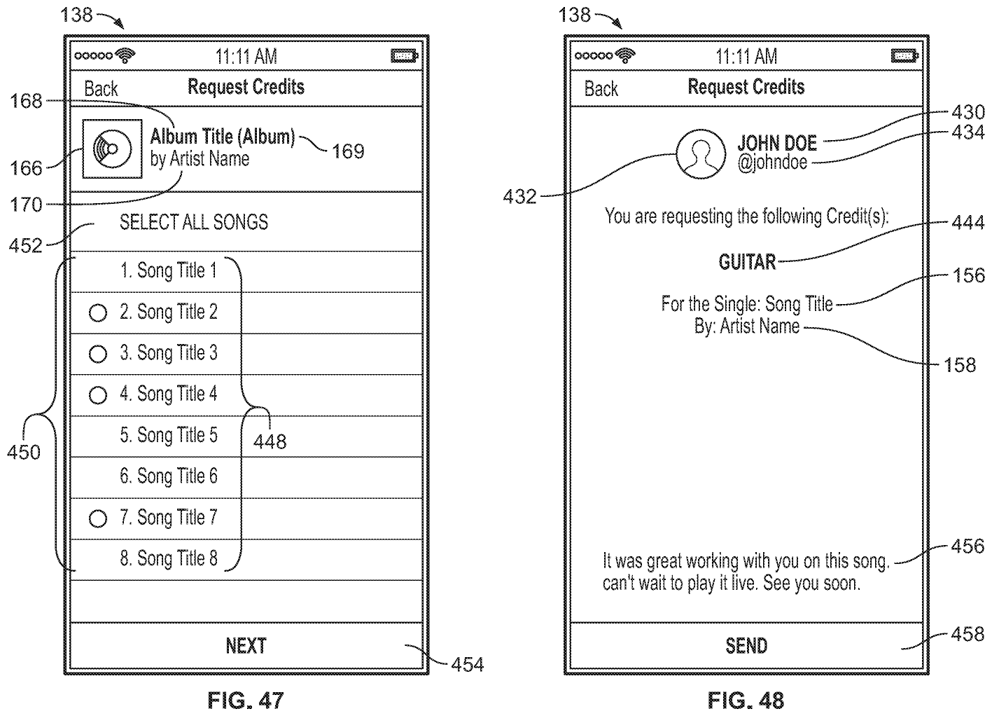

If the musical work non-administrator was adding credits for an album, then after clicking the done button 440 the user interface would display a select songs screen as shown in FIG. 47, which is a screenshot of the user interface 138 showing a select songs screen for an album credit request. The select songs screen shows the album title 168, the music type designation (e.g., album) 169, the artist name 170 associated with the album, a song listing 448 that lists all songs from the album, a plurality of buttons 450 each corresponding to a single song, an all songs button 452, and a next button 454. The musical work non-administrator can select each song he or she would like to request credit for on behalf of the profile currently being administrated by clicking on the appropriate buttons 450 corresponding to the desired songs. If all of the songs on the album are to be requested then the user can click on the all songs button 452. Once the desired songs are selected the musical work non-administrator can click the next button 454 to proceed to this profile's credit request review screen to finalize the credit request.

FIG. 48 is a screenshot of the user interface 138 displaying a profile's request credit review screen for a musical work classified as a single. The profile's request credit review screen displays the requesting profile's name 430, profile's picture 432, and profile's username 434, the previously chosen desired credit category 444, the single title 156, the artist name 158 associated with that single, a personal message 456 if one was entered, and a send button 458. The musical work non-administrator can review the details of the credit request on the request credit review screen, and if everything is correct click the send button 458 to confirm the accuracy.

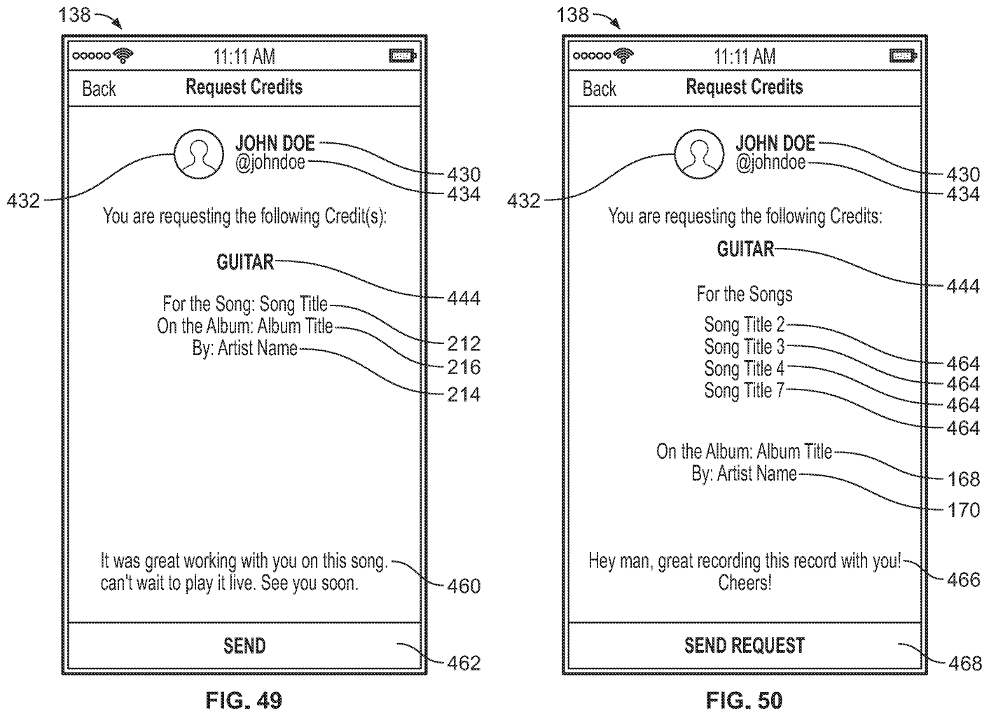

FIG. 49 is a screenshot of the user interface 138 displaying a request credit review screen for a musical work classified as a song from an album. The request credit review screen displays the requesting profile's name 430, profile picture 432, and profile's username 434, the previously chosen desired credit category 444, the song title 212, the artist name 214 associated with that song, the album title 216, a personal message 460 if one was entered, and a send button 462. The musical work non-administrator can review the details of the credit request on the request credit review screen, and if everything is correct click the send button 462 to confirm the accuracy.

FIG. 50 is a screenshot of the user interface 138 displaying a request credit review screen for a musical work classified as an album. The request credit review screen displays the requesting profile's name 430, profile picture 432, and profile's username 434, the previously chosen desired credit category 444, the song titles previously selected 464, the album title 168, the artist name 170 associated with that album, a personal message 466 if one was entered, and a send button 468. The musical work non-administrator can review the details of the credit request on the request credit review screen, and if everything is correct click the send button 468 to confirm the accuracy.

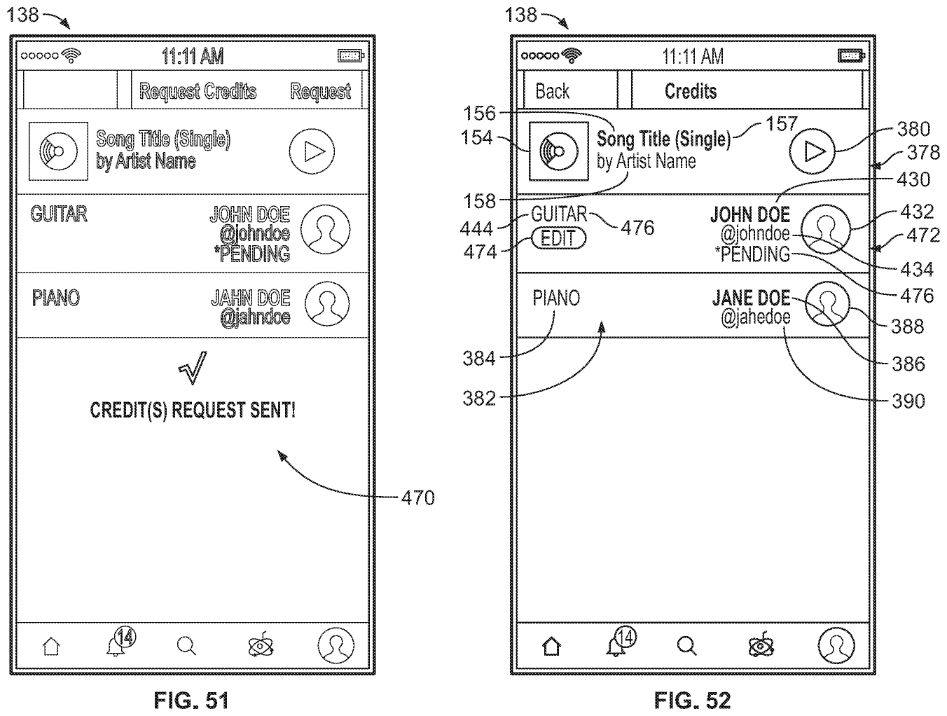

FIG. 51 is a screenshot of the user interface 138 displaying a confirmation pop-up 470 that is displayed to the musical work non-administrator after he or she clicks one of the send buttons 458, 462, 468 in the review screens shown in FIGS. 48-50.

FIG. 52 is a screenshot of the user interface 138 showing the credits screen after the musical work non-administrator has sent a credit request for a single. After a musical work non-administrator sends a credit request for a single, he or she can be returned to the credits screen for that single. As can be seen in FIG. 52, the previously displayed request button 376 (see FIG. 41) is removed, and a pending credit listing 472 is added, which includes the details of the requesting profile's previously sent credit request. Specifically, the pending credit listing 472 includes the requesting profile's name 430, profile picture 432, and profile's username 434 to be credited, and the desired credit category 444. Additionally, an edit button 474, and two pending icons 476 can also placed in the pending credit listing 472. For example, the word “PENDING” along with an asterisk can be placed beneath the profile's username 434, and/or an asterisk can be placed next to the desired credit category 444. The requesting profile's administrator(s) can select or press the edit button 474 to edit the pending credit request, e.g., add additional credit categories to the request. The pending credit listing 472 can also be displayed in a different color font or grayed out font to indicate that it is pending and not authenticated yet, along with a pending icon 476, e.g., an asterisk, next to the pending credit category 444. Pending credit requests may be displayed only to the administrator of the requesting profile on song or single music credits screens.

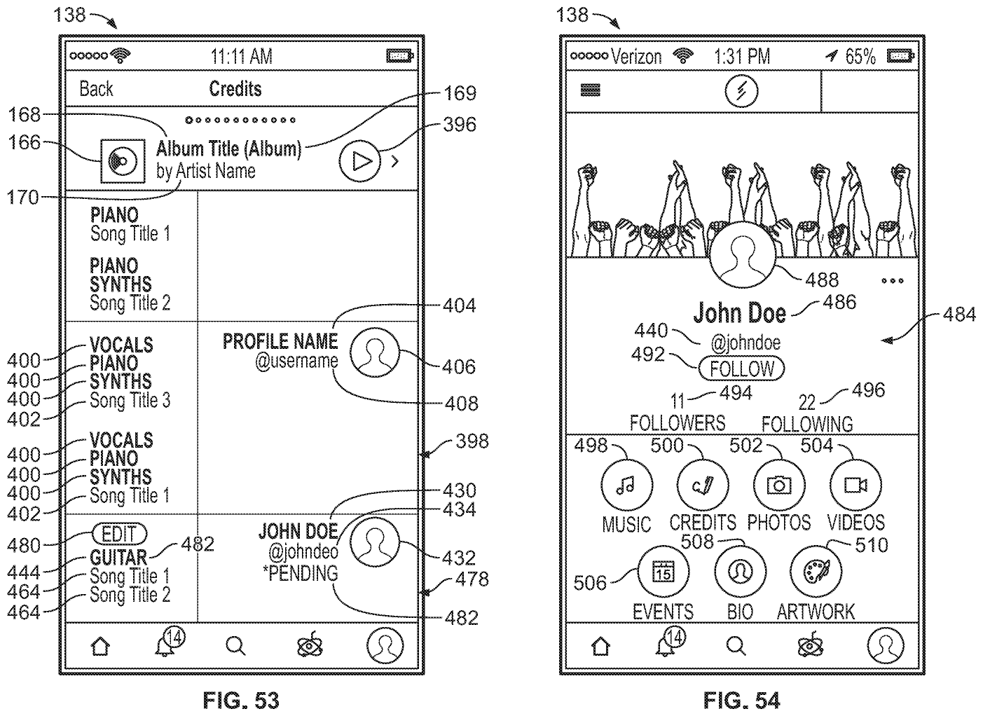

FIG. 53 is a screenshot of the user interface 138 showing the credits screen after the musical work non-administrator has sent a credit request for an album. After a musical work non-administrator sends a credit request for an album, he or she can be returned to the credits screen for that album. As can be seen in FIG. 53, the previously displayed request button 392 (see FIG. 42) is removed, and a pending credit listing 478 is added, which includes the details of the requesting profile's previously sent credit request. Specifically, the pending credit listing 478 includes the requesting profile's name 430, profile picture 432, and profile's username 434 to be credited, the desired credit category 444, and the selected songs 464. Additionally, an edit button 480, and two pending icons 482, are also placed in the pending credit listing 478. For example, the word “PENDING” along with an asterisk can be placed beneath the profile's username 434, and/or an asterisk can be placed next to the desired credit category 444. The requesting profile's administrator(s) can select or press the edit button 480 to edit the pending credit request, e.g., add additional credit categories or songs to the request. The pending credit listing 478 can also be displayed in a different color font or grayed out font to indicate that it is pending and not authenticated yet, along with a pending icon 482, e.g., an asterisk, next to the pending credit category 444. Pending credit requests may be displayed only to the administrator of the requesting profile on album music credits screens.

FIG. 54 is a screenshot of the user interface 138 showing an artist profile or group profile 484. The profile 484 can include various information regarding the profile including the profile's name 486, profile picture 488, and profile's username 490. The profile 484 can also have a follow button 492 that allows other profiles to follow this profile, and can also show the profile's number of followers 494 and number of profiles he or she is following 496. The profile 484 can also include a music button 498, a credits button 500, a photos button 502, a videos button 504, an events button 506, a bio button 508, an artwork button 510, a liner notes button (not shown), a lyrics button (not shown), and a public likes button (not shown). Users can tap the credits button 500 in a profile 484 to access the credits screen for that profile 484.

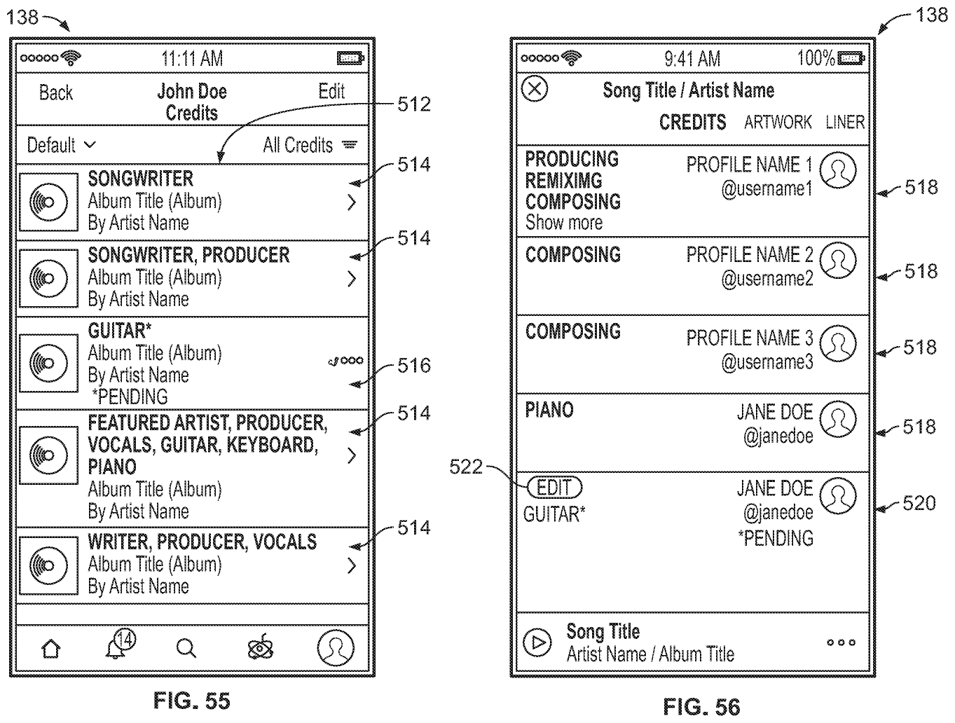

FIG. 55 is a screenshot of the user interface 138 showing a credits screen 512 for a profile. The credits screen 512 shows all authenticated credits 514 and pending credit requests 516 for that profile, and will list the details of the credit. For example, each credit 514, 516 can list the single, album, artist, and credit category for the credit, where appropriate. In some aspects, only authenticated credits and pending credit requests are shown in the credits screen 512 to all users viewing a user's profile, while credit invitations are not shown. For an album credit 516, a user can click on the credit 516, which will cause the user interface to parse out and display each individual credit per song of that album for which the profile has an authenticated credit or pending credit request, as shown and described in connection with FIG. 27B, the functionality of which is incorporated herein. A user can also press the all songs button 315 of FIG. 27B to display not only the credited songs 313 from the selected album, but to also list the non-credited songs 317 from the selected album, as shown and described in connection with FIG. 27C, the functionality of which is incorporated herein.

FIG. 56 is a screenshot of the user interface 138 showing the credits for a song being played through the music player. As can be seen in FIG. 56, both authenticated credits 518 and pending credits 520 can be displayed to an administrator of the requesting profile. That is, in some aspects, pending credit requests 520 may not be shown to the general public, but instead only the authenticated credits 518 are displayed. The pending and authenticated credits 520 can also include an edit button 522 that allows an administrator of the requesting profile to edit any pending credit request or any authenticated credit.

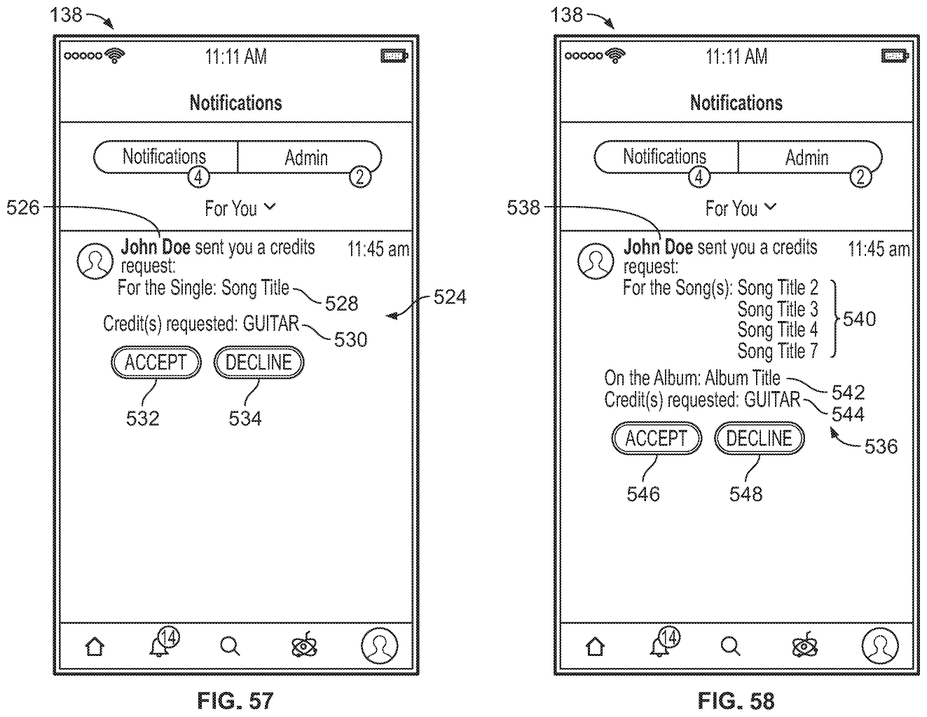

FIG. 57 is a screenshot of the user interface 138 showing a credit request message 524 for a single. After a musical work non-administrator submits a credit request, as detailed above, the credit request message 524 is sent to the administrator(s) of the music work, e.g., from the authentication engine 18. The credit request message 524 for a single includes the profile's name 526 that made the request, the single title 528 for which credit is being requested, and the credit category 530. The credit request message 524 also includes an accept button 532 and a decline button 534. In the case of a song credit, as opposed to a single credit, the album title would also be listed in the credit request message 524. If the musical work administrator and receiver of this message wishes to accept the credit request then he or she can click the accept button 532, which can notify the authentication engine 18 of the musical work administrator's acceptance. The authentication engine 18 will in turn authenticate the credit and update the database 16 accordingly. If the musical work administrator does not wish to accept the credit request then he or she clicks the decline button 534, which can notify the authentication engine 18 of the musical work administrator's declination. The authentication engine 18 will in turn not authenticate the credit and will update the database 16 accordingly, e.g., remove the pending credit.

FIG. 58 is a screenshot of the user interface 138 showing a credit request message 536 for an album. After a musical work non-administrator submits a credit request, as detailed above, the credit request message 536 is sent to the musical work's administrator(s), e.g., from the authentication engine 18. The credit request message 536 for an album includes the profile's name 538 that made the request, a list of the song names 540 for which credit is being requested, the album title 542, and the credit category 544. The credit request message 536 also includes an accept button 546 and a decline button 548. If the musical work's administrator wishes to accept the credit request then he or she can click the accept button 546, which can notify the authentication engine 18 of the musical work administrator's acceptance. The authentication engine 18 will in turn authenticate the credit and update the database 16 accordingly. If the musical work's administrator does not wish to accept the credit request then he or she clicks the decline button 548, which can notify the authentication engine 18 of the musical work administrator's declination. The authentication engine 18 will in turn not authenticate the credit and will update the database 16 accordingly, e.g., remove the pending credit.

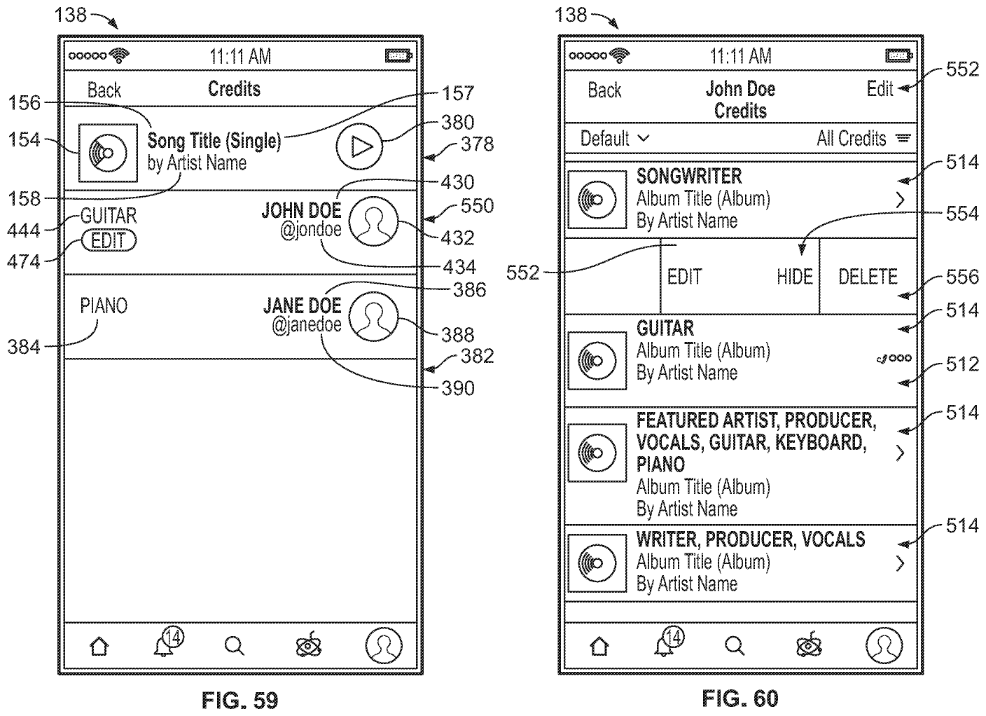

FIG. 59 is a screenshot of the user interface 138 showing the musical work non-administrator music credits screen of FIG. 52 after the musical work administrator has accepted the pending credit and the credit has been authorized. As can be seen in FIG. 59, the previously pending credit listing 472 has turned into an authenticated credit listing 550 with the pending icons 476 removed. The authenticated credit listing 550 includes the credited profile's name 430, profile picture 432, profile's username 434, the credit category 444 previously displayed in the pending credit listing 472, and the edit button 474. The administrators of the credited profile can select or press the edit button to edit the authenticated credit listing 550 and submit a new credit request for this single. Authenticated credits can be shown in three different places: the music credits screen (see FIG. 59), the music player (see FIG. 56), and the profile's credit screen (see FIG. 60).

FIG. 60 is a screenshot of the user interface 138 showing this profile administrator's credits screen 512. As can be seen in FIG. 60, the credits screen 512 shows and displays all authenticated credits 514 and any pending credit requests for the credited profile. For example, each credit 514 lists the single, album, artist name associated with the musical work, and credit category for the credit, where appropriate. In some aspects, only authenticated credits and pending credit requests are shown in the credits screen 512, while credit invitations are not shown. For an album credit, a user can click on the credit 514, which will cause the user interface to parse out and display each individual credit per song of that album for which the profile has an authenticated credit or pending credit request, as shown and described in connection with FIG. 27B, the functionality of which is incorporated herein. A user can also press the all songs button 315 of FIG. 27B to display not only the credited songs 313 from the selected album, but to also list the non-credited songs 317 from the selected album, as shown and described in connection with FIG. 27C, the functionality of which is incorporated herein

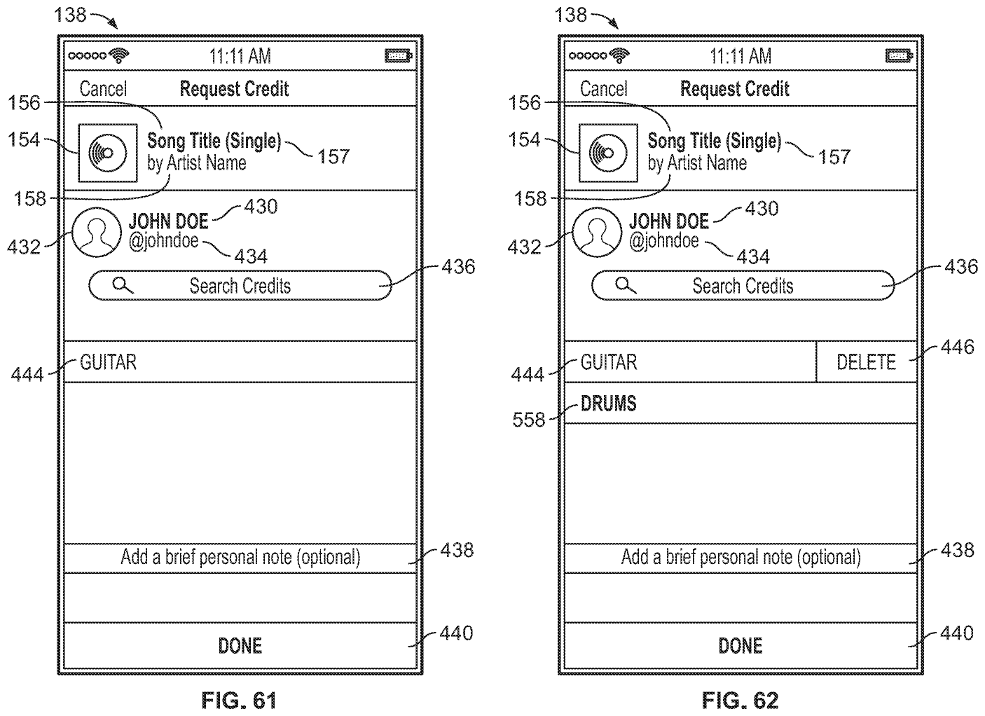

Additionally, administrators of this profile can access the profile's credits screen 512 and swipe left on any credit 514 to open a menu that includes an edit credit button 552, a hide credit button 554, and a delete credit button 556. The credits screen 512 includes an edit button 552, which can be selected or pressed to edit the profile's credits. If an administrator of the profile presses the edit credit button 552, the request credit screen is displayed for that single, song, or album. For example, if the administrator(s) for the profile presses the edit credit button 552 for a single, the request credit screen for that single is displayed, as shown in FIG. 61.

FIG. 61 is a screenshot of the user interface 138 showing the musical work non-administrator's request credit screen for a profile in connection with a single that is displayed after the profiles administrator(s) has selected the edit credit button 552 from the credits screen shown in FIG. 60. The request credit screen can also be accessed when a profile's administrator(s) presses the edit button when in the music credits screen or music player credits screen. The request credit screen shows the single title 156, the music type designation 157 (e.g., single), and artist name 158 associated with the single for which the user has credit, the credited profile's name 430, profile picture 186, and credited profile's username 188, the credit category search bar 436 (see also FIG. 44), the add a note field 438, and the done button 440. While in the profile's request credit screen, this profile's administrator can use the credit category search bar 436 to search for additional credits to request for the profile. The request credit screen for a single can also include a listing of each pending credit request and authorized credit 444 for the profile.

It should be understood that such functionality is not limited to a single, instead a profile's administrator can also access a musical work non-administrator's request credit screen for a song or an album. This can be achieved by the profile's administrator tapping an edit button associated with the profile in the music credits screen for the song or the album, or by swiping left on the single or the album field on the profile's credits screen, e.g., the credits screen shown in FIG. 60, and tapping the edit button, e.g., similar to the edit button 552 shown in FIG. 60.

FIG. 62 is a screenshot of the user interface 138 showing the musical work non-administrator's request credit screen of FIG. 61 after the profile's administrator has added a new credit 558, which can be displayed above or below the already existing pending credit request or authorized credit 444. The new credits 558 and the authorized/pending credits 444 can be displayed in different fonts so that they are easily discernable. For example, the new credits 558 can be displayed in a black font, while authorized/pending credits 444 can be displayed in a blue font. While in the profile's request credit screen, the profile's administrator can edit the credits 444 (both authorized, pending, and newly added) for that profile. For example, the profile's administrator can swipe, e.g., left, on one or more of the profile's credits 444, 558 to display a delete button 446 for that credit 444. Similar functionality can also be performed for a credit applied to individual songs as well as individual songs of an album.

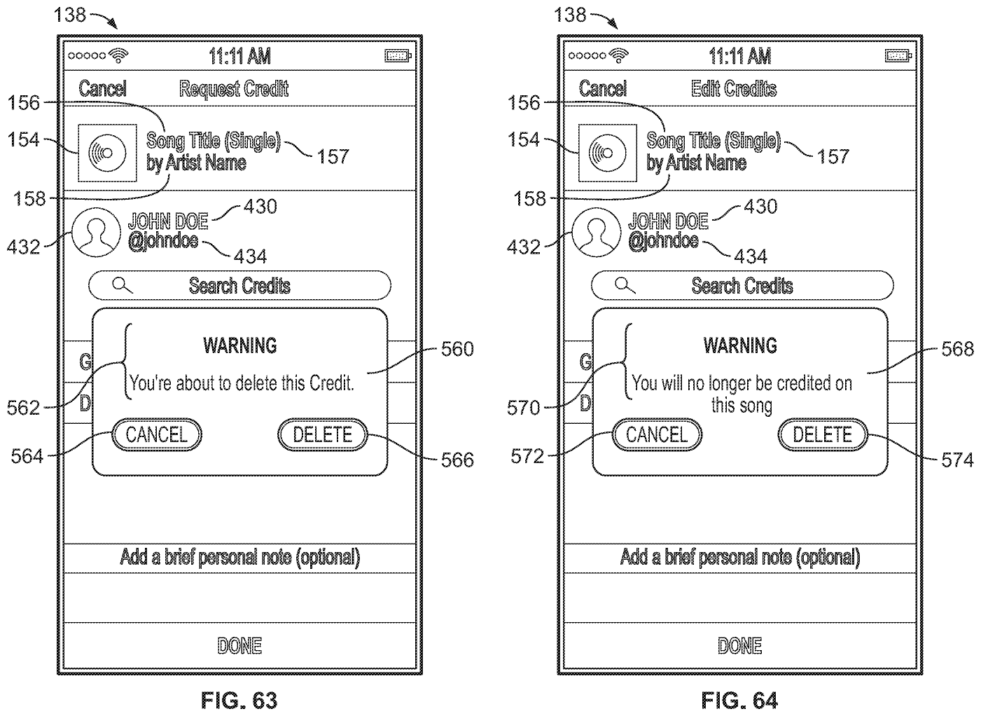

If the profile's administrator selects or presses the delete button 446 from the request credit screens for a profile, a warning popup 560 is displayed to the profile's administrator, as shown in FIG. 63, which is a screenshot of the user interface 138 showing the warning popup 560 displayed after a profile's administrator has chosen to delete a credit from a profile. The warning popup 560 includes a warning message 562 for the profile's administrator, which generally warns the profile's administrator that he or she is about to delete a credit, along with a cancel button 564 and a delete button 566. If the profile's administrator selects the cancel button 564, then he or she will return back to the request credit screen shown in FIG. 62. If the profile's administrator selects the delete button 566, then the credit is deleted from the profile, and the database 16 is updated by the authentication engine 18.

FIG. 64 is a screenshot of the user interface 138 showing a warning popup 568 that is displayed after a profile's administrator has chosen to delete the last credit for the profile on that specific song or single. The warning popup 568 includes a warning message 570 for the profile's administrator, which generally warns the profile's administrator that the profile will no longer be credited on that song, along with a cancel button 572 and a delete button 574. If the profile's administrator selects the cancel button 572, then he or she will return back to the request credit screen shown in FIG. 62. If the profile's administrator selects the delete button 574, then the credit is deleted from the profile, and the database 16 is updated by the authentication engine 18.

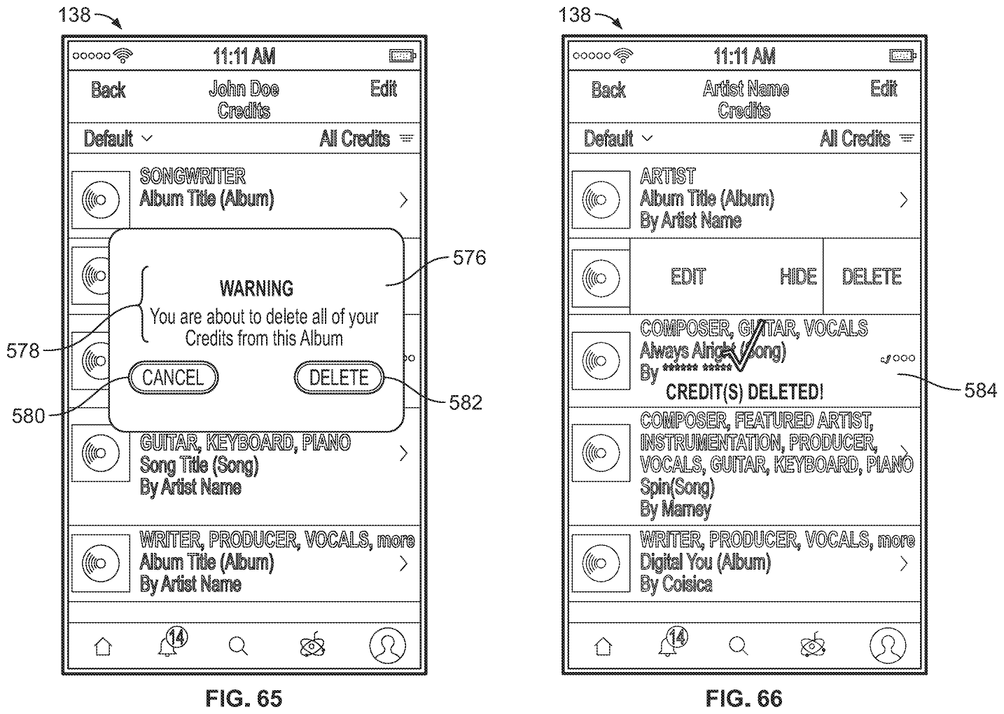

FIG. 65 is a screenshot of the user interface 138 showing a warning popup 576 that is displayed after a profile's administrator presses the delete button 556 shown in FIG. 60 and has therefore chosen to delete an album or single credit field in the profile's credit screen. The warning popup 576 includes a warning message 578 for the profile's administrator, which generally warns the profile's administrator that he or she is about to delete all credits for that single or album, along with a cancel button 580 and a delete button 582. If the profile's administrator selects the cancel button 580, then he or she will return back to the profile's credit screen shown in FIG. 60. If profile's the administrator selects the delete button 582, then the credit is deleted from the profile, and the database 16 is updated by the authentication engine 18.

After a profile's administrator successfully deletes a credit from a profile as shown in FIGS. 63-65, a confirmation pop-up 584 is displayed, as shown in FIG. 66, which is a screenshot of the user interface 138 showing the confirmation pop-up 584 after a profile's administrator has successfully deleted a credit from a profile. The confirmation pop-up 584 automatically disappears after a few moments and returns the profile's administrator to the profile's credits screen shown in FIG. 60, or to the non-administrator's request credit screen for the song, single, or album as shown in FIG. 62, depending on where the profile's administrator initiated the deletion of the credits.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

1. A method for crediting a profile for a musical work through authentication of a credit, comprising:
receiving a selection of at least one credit for a musical work to be attributed to an invited profile by an authorized administrator for the musical work;
updating a database to include the at least one credit as at least one pending credit for the musical work;
generating an electronic credit invitation that includes the at least one pending credit for the musical work;
transmitting the electronic credit invitation to an administrator of the invited profile;
determining whether the administrator of the invited profile authorizes the at least one pending credit; and
updating a status of the at least one pending credit for the musical work in the database based on the determination.

2. The method of claim 1, comprising:
determining that the administrator of the invited profile authorizes the at least one pending credit;
authenticating the at least one pending credit; and
updating the database to credit the profile for the musical work by changing the at least one pending credit to a confirmed credit.

3. The method of claim 2, wherein the confirmed credit is viewable by other users when viewing the musical work through a music player on a smart device or computer.

4. The method of claim 1, comprising:
determining that the administrator of the invited profile denies authorization of the at least one pending credit; and
updating the database to remove the at least one unauthorized pending credit from the database.

5. The method of claim 1, wherein the musical work is at least one of a song, a single, or an album.

6. The method of claim 1, wherein the selection is received from a smart device or computer.

7. A method for crediting a profile on a musical work through electronic authentication of a credit, comprising:
receiving a request for at least one credit for a musical work from an administrator of a profile;
updating a database to include the at least one credit as at least one pending credit for the musical work;
generating a credit request that includes the at least one pending credit for the musical work;
transmitting the credit request to an administrator of the musical work;
determining whether the administrator of the musical work authorizes the at least one pending credit; and
updating a status of the at least one pending credit for the musical work in the database based on the determination.

8. The method of claim 7, comprising:
determining that the administrator of the musical work authorizes the at least one pending credit;
authenticating the at least one pending credit; and
updating the database to credit the profile for the musical work by changing the at least one pending credit to a confirmed credit.

9. The method of claim 8, wherein the confirmed credit is viewable by other users when viewing the musical work through a music player on a smart device or computer.

10. The method of claim 7, comprising:
determining that the administrator of the musical work denies authorization of the at least one pending credit; and
updating the database to remove the at least one unauthorized pending credit from the database.

11. The method of claim 7, wherein the musical work is at least one of a song, a single, or an album.

12. The method of claim 7, wherein the credit is requested by the administrator of the profile through a music player on a smart device or computer.

13. A system for crediting a profile for a music work through authentication of a credit, comprising:
a database; and
a processor in communication with the database and one or more smart devices, the processor including an authentication engine and being configured to authenticate a musical credit by performing the steps of:
receiving a selection of at least one credit for a musical work to be attributed to an invited profile from an authorized administrator for the musical work;
updating the database to include the at least one credit as at least one pending credit for the musical work;
generating an electronic credit invitation that includes the at least one pending credit for the musical work;
transmitting the credit invitation to an administrator of the invited profile;
determining whether the administrator of the invited profile authorizes the at least one pending credit; and
updating a status of the at least one pending credit for the musical work in the database based on the determination.

14. The system of claim 13, the processor further performing the steps of:
determining that the administrator of the invited profile authorizes the at least one pending credit;
authenticating the at least one pending credit; and
updating the database to credit the profile for the musical work by changing the at least one pending credit to a confirmed credit.

15. The system of claim 14, wherein the confirmed credit is viewable by other users when viewing the musical work through a music player on a smart device or computer.

16. The method of claim 13, the processor further performing the steps of:
determining that the administrator of the invited profile denies authorization of the at least one pending credit; and
updating the database to remove the at least one unauthorized pending credit from the database.

17. The method of claim 13, wherein the musical work is at least one of a song, a single, or an album.

18. The method of claim 13, wherein the selection is received by the processor from a smart device or computer.

19. A system for crediting a profile for a music work through authentication of a credit, comprising:
a database; and
a processor in communication with the database and one or more smart devices, the processor including an authentication engine and being configured to authenticate a musical credit by performing the steps of:
receiving a request for at least one credit for a musical work from an administrator of a profile;
updating the database to include the at least one credit as at least one pending credit for the musical work;
generating a credit request that includes the at least one pending credit for the musical work;
transmitting the credit request to an administrator of the musical work;
determining whether the administrator of the musical work authorizes the at least one pending credit; and
updating a status of the at least one pending credit for the musical work in the database based on the determination.

20. The system of claim 19, comprising:
determining that the administrator of the musical work authorizes the at least one pending credit;
authenticating the at least one pending credit; and
updating the database to credit the profile for the musical work by changing the at least one pending credit to a confirmed credit.

21. The system of claim 20, wherein the confirmed credit is viewable by other users when viewing the musical work through a music player on one of the one or more smart devices or computer.

22. The system of claim 19, comprising:
determining that the administrator of the musical work denies authorization of the at least one pending credit; and
updating the database to remove the at least one unauthorized pending credit from the database.

23. The system of claim 19, wherein the musical work is at least one of a song, a single, or an album.

24. The method of claim 19, wherein the credit is requested by the administrator of the profile through a music player on one of the one or more smart devices or a computer.
